(19) United States
(12) Patent Application Publication
(10) Pub. No.: US 2009/0035038 A1
(43) Pub. Date: Feb. 5, 2009

(54) CLEANING DEVICE, IMAGE CARRIER UNIT, AND IMAGE FORMING APPARATUS

(76) Inventors: Naomi Sugimoto, Kanagawa (JP); Hidetoshi Yano, Kanagawa (JP); Kenji Sugiura, Kanagawa (JP); Osamu Naruse, Kanagawa (JP); Hiroki Nakamatsu, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/184,554

(22) Filed: Aug. 1, 2008

(30) Foreign Application Priority Data
Aug. 3, 2007 (JP) 2007-203469
Oct. 9, 2007 (JP) 2007-263825

(51) Int. Cl. G03G 21/00

(52) U.S. Cl. 399/354

(57) ABSTRACT

A brush roller includes conductive brush fibers and a conductive rotating shaft, and rotates around the rotating shaft so that the brush fibers make contact with a cleaning target to remove dirt from a surface of the cleaning target. A brush-roller cleaning unit makes contact with the brush fibers to remove the dirt from the brush fibers. A brush-fiber charge imparting unit makes contact with the brush fibers on a downstream side of a location where the brush-roller cleaning unit makes contact with the brush fibers and on an upstream side of a location where the brush fibers make contact with the cleaning target in rotation direction of the brush roller.

### CROSS-REFERENCE TO RELATED APPLICATIONS

The present application claims priority to and incorporates by reference the entire contents of Japanese priority document 2007-203469 filed in Japan on Aug. 3, 2007 and Japanese priority document 2007-263825 filed in Japan on Oct. 9, 2007.

### BACKGROUND OF THE INVENTION

1. Field of the Invention

The present invention relates to a cleaning device used in an image forming apparatus such as a copier, a facsimile, and a printer, and an image forming apparatus and an image carrier unit each of which has the cleaning device.

2. Description of the Related Art

As a conventional cleaning unit for removing toner remaining on a photosensitive element after a toner image is transferred from the photosensitive element as an element to be cleaned, there is known a blade cleaning system for contacting a rubber blade with the photosensitive element to remove toner therefrom. The blade cleaning system has such characteristics that if the degree of contact between the blade and the photosensitive element is low, toner scrapes through therebetween, to cause a cleaning capability to decrease. To prevent this, the blade is pushed against the photosensitive element with high contact pressure. However, pushing the blade against the photosensitive element with the high contact pressure causes the blade to warp, which causes a streak-like or a band-shaped cleaning failure to occur, so that it is difficult to keep stable cleaning performance. Besides, scrape of the surface film of the photosensitive element is thereby increased and life of the photosensitive element is reduced in the long term.

Recently, high image quality is increasingly demanded, and the particle size of toner therefore tends to be reduced. Moreover, reduction of toner manufacturing costs and increase in a transfer rate of toner are demanded, and thus an image forming apparatus using spherical toner is commercialized, the spherical toner being obtained by forming pulverized (amorphous) toner into a spherical shape using a polymerization method. It is known that use of such small sized and spherical toner causes the cleaning performance to be inferior to that of the pulverized toner in the blade cleaning system.

Japanese Patent Application Laid-Open No. 2005-265907 describes an electrostatic brush cleaning system being a cleaning system that has excellent cleaning performance even upon cleaning of the small-sized toner and the spherical toner and minimizes mechanical rubbing capable of reducing scraping of the surface film of the photosensitive element. In the electrostatic brush cleaning system described therein, a conductive brush is disposed so as to contact and rub the surface of the photosensitive element with the conductive brush, and a collecting roller is further disposed so as to contact the conductive brush, so that toner is removed from the collecting roller using a cleaning unit formed of a rubber blade. In this case, a voltage is applied to the collecting roller or to both the conductive brush and the collecting roller, and toner is removed from the photosensitive element using the electrostatic force in addition to the rubbing force due to the brush. Therefore, the cleaning performance for the small-sized toner and the spherical toner can be obtained.

The electrostatic brush cleaning system removes toner charged to an opposite polarity to that of the voltage applied to the conductive brush by attracting the toner from the photosensitive element using the electrostatic force. However, it is found that cleaning performed by the conductive brush causes generation of not only toner that adheres to the conductive brush due to the electrostatic force but also toner injected with charge from the conductive brush. The toner injected with charge from the conductive brush is charged to the polarity the same as that of the voltage applied to the conductive brush, and the toner is thereby impossible to be removed by the conductive brush. Some toner that is not caught by the conductive brush passes through an opposed portion to a cleaning device on the surface of the photosensitive element, which results in a cleaning failure.

To solve the problem, the inventors of the present invention propose a cleaning device in Japanese Patent Application No. 2006-275702. The cleaning device includes a cleaning brush having conductive brush fibers, each of which an inner side is formed of a conductive material and a surface portion is formed of an insulating material. A voltage is then applied to a core bar of the brush and to a shaft of a collecting roller. The cleaning device electrostatically attracts the toner by applying a voltage to the conductive material provided inside the brush fiber of the cleaning brush. Meanwhile, the insulating material on the surface portion prevents contact between the conductive material applied with the voltage and the toner. With this feature, the toner can be removed from an element to be cleaned by electrostatically attracting toner to the cleaning brush. Besides, by preventing the contact between the conductive material and the toner, it is possible to minimize the charge to be injected to the toner that is to be removed from the cleaning brush, and thus preventing occurrence of a cleaning failure caused by the charge injection.

However, as a result of experiments conducted by the cleaning device having the configuration described in Japanese Patent Application No. 2006-275702, it is found that the following problem arises. Specifically, a tip potential of the brush fibers is measured after a process such that toner adheres to the brush fibers and then the toner is removed therefrom by the collecting roller. As a result, it is found that the tip potential of the brush fibers decreased with increasing amount of toner adhesion per unit area.

The reason that the tip potential of the brush fibers decreases does not become apparent yet. However, it can be thought that peel discharge may occur when the toner moves from the brush fibers to the collecting roller and this causes charge with the same polarity as the charge polarity of the toner to be given to surfaces of the brush fibers formed of the insulating material. Alternatively, it can also be thought that after the charge with the same polarity as the charge polarity of toner is given to the surfaces of the brush fibers due to toner adhesion and the toner is removed by the collecting roller, the charge with the same polarity as the charge polarity of the toner may remain the surfaces of the brush fibers.

The peel discharge between the toner and the brush fibers is caused due to a potential difference between the toner and the surfaces of the brush fibers when the toner is pulled away from the brush fibers. Thus, the peel discharge may be produced not only by using a cleaning unit such as the collecting roller that electrostatically removes the toner from the brush fibers but also by using a brush-roller cleaning unit like a flicker that mechanically removes the toner.

In the brush-roller cleaning unit such as the collecting roller that electrostatically removes toner, charge is also electrostatically attracted to the brush-roller cleaning unit together with the toner, the charge having the same polarity as that of the toner having moved to the surfaces of the brush fibers. Meanwhile, the configuration such as the flicker that mechanically removes toner does not generate electrostatic force for attracting the charge with the same polarity as the toner having moved to the surfaces of the brush fibers to the brush-roller cleaning unit. Therefore, as compared with the configuration that electrostatically removes toner from the brush fibers, the brush-roller cleaning unit that mechanically removes toner more easily causes the charge with the same polarity as the charge polarity of the toner to remain on the brush roller after the toner is removed.

As explained above, the brush-roller cleaning unit that removes toner from the brush roller may cause peel discharge to occur when the toner is removed from the brush roller or may cause the charge with the same polarity as the charge polarity of the toner to remain on the brush roller after the toner is removed. Thus, the decrease of the tip potential of the brush fibers may be caused by using not only the collecting roller as the brush-roller cleaning unit but also any brush-roller cleaning unit that removes the toner from the brush roller.

### SUMMARY OF THE INVENTION

It is an object of the present invention to at least partially solve the problems in the conventional technology.

According to an aspect of the present invention, there is provided a cleaning device including a brush roller including conductive brush fibers that extend outward from an outer periphery of a conductive rotating shaft in a radial direction, the brush roller rotating around the rotating shaft so that the brush fibers make contact with a cleaning target having a moving surface to remove dirt from the surface of the cleaning target; a first voltage applying unit that applies a voltage to the rotating shaft; a brush-roller cleaning unit that makes contact with the brush fibers at a location different from a location where the brush fibers make contact with the cleaning target, and removes the dirt from the brush fibers; a brush-fiber charge imparting unit that makes contact with the brush fibers on a downstream side of a location where the brush-roller cleaning unit makes contact with the brush fibers in a rotation direction of the brush roller and on an upstream side of a location where the brush fibers make contact with the cleaning target in the rotation direction of the brush roller, and is applied with a voltage with same polarity as the voltage applied to the brush fibers; and a second voltage applying unit that applies the voltage to the brush-fiber charge imparting unit. Each of the brush fibers has an inner portion formed of a conductive material and a surface portion formed of an insulating material.

Furthermore, according to another aspect of the present invention, there is provided an image carrier unit that integrally supports an image carrier as a cleaning target and a cleaning unit that cleans a surface of the image carrier, and is installed in an image forming apparatus in a detachable manner. The cleaning unit includes a brush roller including conductive brush fibers that extend outward from an outer periphery of a conductive rotating shaft in a radial direction, the brush roller rotating around the rotating shaft so that the brush fibers make contact with the image carrier to remove toner from the surface of the image carrier; a first voltage applying unit that applies a voltage to the rotating shaft; a brush-roller cleaning unit that makes contact with the brush fibers at a location different from a location where the brush fibers make contact with the image carrier, and removes the toner from the brush fibers; a brush-fiber charge imparting unit that makes contact with the brush fibers on a downstream side of a location where the brush-roller cleaning unit makes contact with the brush fibers in a rotation direction of the brush roller and on an upstream side of a location where the brush fibers make contact with the image carrier in the rotation direction of the brush roller, and is applied with a voltage with same polarity as the voltage applied to the brush fibers; and a second voltage applying unit that applies the voltage to the brush-fiber charge imparting unit. Each of the brush fibers has an inner portion formed of a conductive material and a surface portion formed of an insulating material.

Moreover, according to still another aspect of the present invention, there is provided an image forming apparatus including an image carrier; a charging unit that charges the image carrier; a latent image forming unit that forms the latent image on the image carrier; a developing unit that develops the latent image formed on the image carrier using toner so that a toner image is formed on the image carrier; a transfer unit that transfers the toner image from the image carrier to a subsequent medium; and a cleaning unit that removes residual toner from the image carrier after the toner image is transferred. The cleaning unit includes a brush roller including conductive brush fibers that extend outward from an outer periphery of a conductive rotating shaft in a radial direction, the brush roller rotating around the rotating shaft so that the brush fibers make contact with the image carrier to remove toner from the surface of the image carrier, a first voltage applying unit that applies a voltage to the rotating shaft, a brush-roller cleaning unit that makes contact with the brush fibers at a location different from a location where the brush fibers make contact with the image carrier, and removes the toner from the brush fibers, a brush-fiber charge imparting unit that makes contact with the brush fibers on a downstream side of a location where the brush-roller cleaning unit makes contact with the brush fibers in a rotation direction of the brush roller and on an upstream side of a location where the brush fibers make contact with the image carrier in the rotation direction of the brush roller, and is applied with a voltage with same polarity as the voltage applied to the brush fibers, and a second voltage applying unit that applies the voltage to the brush-fiber charge imparting unit. Each of the brush fibers has an inner portion formed of a conductive material and a surface portion formed of an insulating material.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a printer according to a first embodiment;

FIG. 2 is a schematic of a printer according to a conventional example;

FIG. 3 is a graph representing a charge potential distribution of toner carried on a photosensitive element right before transfer thereof and a charge potential distribution of “residual toner after transfer” remaining on the photosensitive element after a toner image is transferred;

FIG. 4 is a schematic for explaining a cleaning blade when the surface of the photosensitive element moves;

FIG. 5 is a graph representing a charge potential distribution of toner carried on the photosensitive element after transfer thereof and a charge potential distribution of residual toner after transfer having passed through an opposed portion to the cleaning blade;

FIG. 6 is a graph representing changes of a charge potential distribution of residual toner after transfer when a voltage applied to the cleaning blade is changed;

FIG. 7 is a vertical cross-section of a brush fiber of the cleaning brush according to the first embodiment;

FIG. 8 is a vertical cross-section of the brush fiber of the cleaning brush when the brush fiber is straight;

FIG. 9 is a graph representing each potential of the cleaning brush and a collecting roller and each potential difference between them when the collecting roller according to the conventional example is used in an environment of 32° C. and 80%;

FIG. 10 is a graph representing each potential of the cleaning brush and a collecting roller and each potential difference between them when the collecting roller according to a comparative example is used in the environment of 32° C. and 80%;

FIG. 11 is a graph representing a collection rate with respect to a potential difference between a tip of the brush and a surface of the collecting roller;

FIG. 12 is a graph representing a relationship between an applied voltage to the collecting roller and residual ID after cleaning;

FIG. 13 is a schematic for explaining an experimental apparatus used to explain decrease in the potentials at the tip of the brush and at the surface of the collecting roller;

FIG. 14 is a graph representing results of measuring the surface potential of the collecting roller and the tip potential of the brush using a surface potentiometer for 10 seconds while inputting toner thereto in the experimental apparatus;

FIG. 15 is a graph representing results of measuring the surface potential of the collecting roller and the tip potential of the brush using the surface potentiometer for two seconds while inputting toner thereto in the experimental apparatus;

FIG. 16 is a graph representing results of measuring the surface potential of the collecting roller and the tip potential of the brush using the surface potentiometer for 10 seconds without inputting toner thereto in the experimental apparatus;

FIG. 17 is a graph representing results of measuring the surface potential of the collecting roller and the tip potential of the brush using the surface potentiometer while inputting toner thereto using the collecting roller according to a present example in the experimental apparatus;

FIG. 18 is a graph representing a relationship between a tip potential of the brush and residual ID after cleaning in an environment of 10° C. and 15%;

FIG. 19 is a graph representing a relationship between a tip potential of the brush and residual ID after cleaning in an environment of 32° C. and 80%;

FIG. 20 is a graph representing fluctuation of a tip potential of the brush when measures are taken against the fluctuation of the tip potential of the brush;

FIG. 21 is a graph representing fluctuation of a tip potential of the brush when an applied voltage to a collecting-roller cleaning blade is increased in a configuration in which the measures are taken against the fluctuation of the tip potential of the brush;

FIG. 22 is a schematic indicative of a relationship among lengths of components in an axial direction of the photosensitive element;

FIG. 23 is a schematic of a charging roller in contact with the photosensitive element;

FIG. 24 is a schematic of a charging unit as a corona charger;

FIG. 25 is a schematic of the charging unit as a magnetic brush;

FIG. 26 is a schematic of the charging unit as a fur brush;

FIGS. 27A to 27D are schematics for explaining layer structures of an amorphous-silicon photosensitive element;

FIG. 28 is a schematic representing a shape of a toner particle for explaining shape factor SF-1;

FIG. 29 is a schematic representing a shape of a toner particle for explaining shape factor SF-2;

FIG. 30 is a schematic of a process cartridge;

FIG. 31 is a schematic of a main portion of a tandem-type full-color image forming apparatus;

FIG. 32 is a schematic of a main portion of a one-drum type full-color image forming apparatus;

FIG. 33 is a schematic of a configuration in which a cleaning device is provided for a paper conveyor belt;

FIG. 34 is a schematic of a printer according to a second embodiment;

FIG. 35 is a graph representing a relationship between contact depth and cleaning performance;

FIG. 36 is a schematic for explaining a configuration in which a brush-charge imparting unit is biased by a coil spring to press the cleaning brush;

FIG. 37 is a graph representing a relationship between pressing force and cleaning performance when the pressing force by the coil spring is changed;

FIG. 38 is a schematic for explaining a configuration in which the brush-charge imparting unit is biased using elasticity thereof to press the cleaning brush;

FIGS. 39A and 39B are enlarged schematics of brush-charge imparting units formed of a plate spring; and

FIG. 40 is a schematic of a printer including a cleaning device of a flicker bar system.

### DETAILED DESCRIPTION OF THE PREFERRED EMBODIMENTS

Exemplary embodiments of the present invention are explained in detail below with reference to the accompanying drawings.

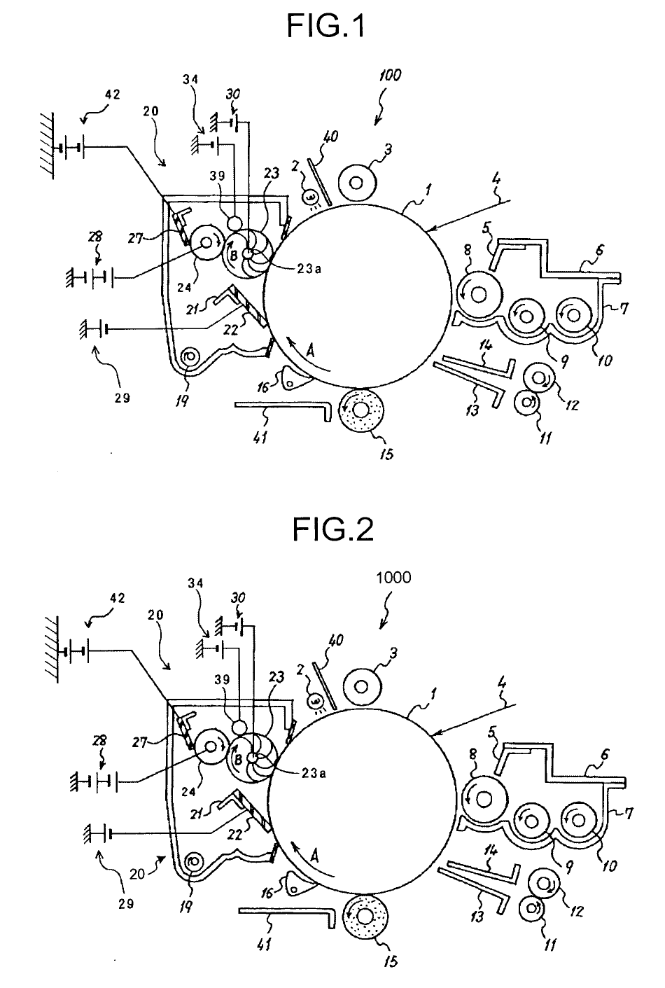

FIG. 1 is a schematic of a main portion of a printer 100 according to a first embodiment of the present invention; and FIG. 2 is a schematic of a main portion of a printer 1000 according to a conventional technology described in Japanese Patent Application No. 2006-275702. The printers 100 and 1000 perform single-color copying in such a manner that a monochromatic image is formed based on image data read by an image reader (not shown).

First, a common configuration between the printer 100 shown in FIG. 1 and the printer 1000 shown in FIG. 2 will be explained.

The configuration of the entire printer 100 will be explained below.

The printer 100 includes a drum-shaped photosensitive element 1 as an image carrier. Arranged around the photosensitive element 1 are a noncontact charging roller 3 as a charging unit, and a developing device 6 as a developing unit or a toner-image forming unit that forms a latent image into a toner image. Further arranged around the photosensitive element 1 are a transfer roller 15 being a transfer unit that transfers the formed toner image to a transfer paper as a recording medium, a cleaning device 20 being a cleaning unit that cleans toner remaining on the surface of the photosensitive element 1 after toner is transferred, and a neutralizing lamp 2 that neutralizes the surface of the photosensitive element 1. A light shielding plate 40 that shields light of the neutralizing lamp 2 is provided between the neutralizing lamp 2 and the charging roller 3.

The charging roller 3 is arranged at a location in a noncontact manner with a predetermined distance to the surface of the photosensitive element 1, and the surface of the photosensitive element 1 is charged to a predetermined polarity and a predetermined potential. In the printer 100, the surface of the photosensitive element 1 is uniformly charged to a negative polarity.

The uniformly charged surface of the photosensitive element 1 is irradiated with a laser beam 4 from an exposing device (not shown) based on image data, and an electrostatic latent image is formed thereon.

The developing device 6 includes a developing roller 8 being a developer carrier that includes a magnet as a magnetic field generator. A developing bias is applied to the developing roller 8 from a power supply (not shown). Arranged inside a casing 7 of the developing device 6 are a supply screw 9 and a stirring screw 10 that stir two-component developer containing toner and carrier stored in the casing 7 while conveying the developer in mutually opposite directions. A doctor 5 is also arranged to restrict the developer carried on the developing roller 8.

The toner in the developer stirred and conveyed by the two screws such as the supply screw 9 and the stirring screw 10 is charged to the negative polarity. The developer is sucked up to the developing roller 8 by the action of the magnet included in the developing roller 8. The sucked-up developer is restricted by the doctor 5 and becomes toner chains due to magnetic force of the magnet in a developing area opposite to the photosensitive element 1, to form magnetic brushes.

A transfer bias is applied to the transfer roller 15 from the power supply (not shown).

An image forming operation in the printer 100 will be explained next.

In the printer 100, a print start button in an operating unit (not shown) is pressed, and an image reader (not shown) starts reading an original. Meanwhile, predetermined voltages or currents are sequentially applied, at predetermined timing, to the charging roller 3, the developing roller 8, the transfer roller 15, a cleaning brush 23, a polarity control blade 22, a cleaning-brush charge imparting unit 39, and a collecting roller 24, respectively. Similarly, predetermined voltages or currents are sequentially applied, at predetermined timing, to a collecting-roller cleaning blade 27 and the neutralizing lamp 2, respectively. In synchronization with the application, the photosensitive element 1 is made to rotate in a direction of arrow A in FIG. 1 by a photosensitive-element drive motor (not shown) as a drive unit. Simultaneously with the rotation of the photosensitive element 1, the noncontact type charging roller 3, the developing roller 8, the transfer roller 15, the supply screw 9, the stirring screw 10, a toner discharging screw 19 of which details are explained later, the cleaning brush 23, and the collecting roller 24 are also made to rotate in predetermined directions respectively.

Upon rotation of the photosensitive element 1 in the direction of arrow A in FIG. 1, the surface of the photosensitive element 1 is first charged to a potential of, for example, −700 volts by the charging roller 3 of a charging device. Then, the laser beam 4 corresponding to an image signal is irradiated onto the photosensitive element 1 from the exposing device (not shown), the charge level of a portion on the photosensitive element 1 irradiated with the laser beam 4 is changed, to form an electrostatic latent image (for example, a potential of a solid black portion is −120 volts).

The surface of the photosensitive element 1 with the electrostatic latent image formed thereon is rubbed with the magnetic brushes of the developer formed on the developing roller 8 at the opposed portion to the developing device 6. At this time, the negatively charged toner on the developing roller 8 moves to the photosensitive element 1 side caused by a potential difference between a developing bias of, for example, −450 volts applied to the developing roller 8 and the surface of the photosensitive element 1, and the electrostatic latent image on the surface thereof is formed into a toner image, or is developed. In this manner, in the first embodiment, the electrostatic latent image formed on the photosensitive element 1 is subjected to reversal development using the toner charged to the negative polarity by the developing device 6. The first embodiment explains an example of using an N/P (negative/positive: toner adheres to a low potential portion) noncontact charging roller system, but it is not limited thereto.

The toner image formed on the photosensitive element 1 is transferred to a transfer paper that is fed to a transfer area formed between the photosensitive element 1 and the transfer roller 15 by passing through the opposed portion between an upper registration roller 11 and a lower registration roller 12 from a paper feed unit (not shown) and being guided by guide plates 13 and 24. At this time, the transfer paper is fed thereto in synchronization with the edge of an image at the opposed portion between the upper registration roller 11 and the lower registration roller 12. Upon transfer of the toner image to the transfer paper, a transfer bias which is controlled to a constant current of, for example, +10 microamperes to the transfer roller 15. The transfer paper with the toner image thereon is separated from the photosensitive element 1 by a separation claw 16 as a separation unit, and guided by a conveying guide plate 41, to be conveyed to a fixing device as a fixing unit (not shown). The toner image is fixed on the transfer paper under heat and pressure while passing through the fixing device, and the transfer paper is discharged to the outside of the device.

Meanwhile, “residual toner after a toner image is transferred” (hereinafter, “residual toner”) is removed by the cleaning device 20 from the surface of the photosensitive element 1 after the toner image is transferred, and further, the surface thereof is neutralized by the neutralizing lamp 2.

The cleaning device 20 that removes the toner from the surface of the photosensitive element 1 as an element to be cleaned will be explained next.

As shown in FIGS. 1 and 2, the cleaning device 20 includes the cleaning brush 23 which is a brush roller applied with a positive voltage from a brush power supply 30 being a brush-roller voltage applying unit. Further, the conductive polarity control blade 22 applied with a negative voltage from a blade power supply 29 is arranged at a location opposite to the surface of the photosensitive element 1 in the upstream side of the location where the cleaning brush 23 removes the toner from the photosensitive element 1 in the direction of movement of the surface thereof.

The cleaning brush 23 is a brush roller that rotates around a core bar 23a, and the brush power supply 30 applies a voltage to the core bar 23a.

The charge amount of the toner being the residual toner that adheres to the surface of the photosensitive element 1 and reaches the opposed portion to the cleaning device 20 will be explained below.

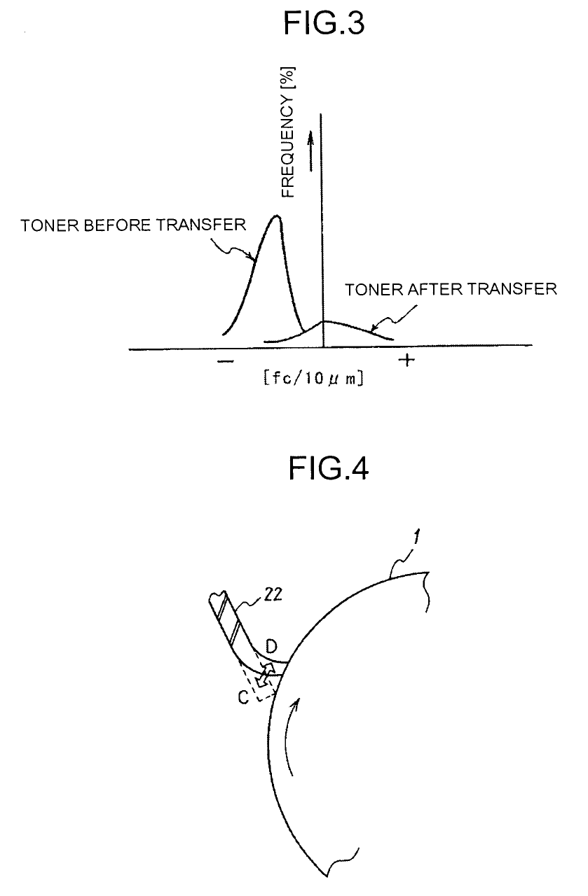

FIG. 3 is a graph representing a charge potential distribution (toner q/d distribution) of toner carried on the photosensitive element 1 right before transfer thereof and a charge potential distribution of the residual toner remaining on the photosensitive element 1 after a toner image is transferred. It is noted that the charge amount distribution was measured by E-SPART Analyzer manufactured by Hosokawa Micron Corp. In the graph, the vertical axis represents a ratio with respect to the number of collected toner particles, and the horizontal axis represents the charge amount of one toner particle. The number of collected toner particles this time is set to 500 because of a small number of “residual toner particles after a toner image is transferred” (hereinafter, “residual toner particles”).

As shown in FIG. 3, most of the toner particles on the surface of the photosensitive element 1 before transfer are charged to the negative polarity. Most of the toner particles charged to the positive polarity before transfer adhere to the photosensitive element 1 as they are upon transfer. Further, even if the toner particles are charged to the negative polarity before transfer, the charge polarity may sometimes be reversed to the positive polarity due to injection of charge with the positive polarity applied to the transfer roller 15. Consequently, as shown in FIG. 3, the residual toner particles on the surface of the photosensitive element 1 are distributed in such a manner that toner particles with the positive polarity and toner particles with the negative polarity are mixed.

The residual toner particles that adhere to the surface of the photosensitive element 1 pass through the opposed portion to the transfer roller 15 and reach an opposed position to the polarity control blade 22 through movement of the surface thereof.

FIG. 4 is a schematic for explaining the polarity control blade 22 during movement of the surface of the photosensitive element 1. Most of the residual toner particles having reached the opposed position to the polarity control blade 22 are mechanically scraped off by the polarity control blade 22. However, as shown in FIG. 4, so-called stick-slip occurs when the polarity control blade 22 is cleaning the surface of the photosensitive element 1, and part of the residual toner particles pass through the opposed portion to the polarity control blade 22.

A voltage with the negative polarity (e.g., −450 volts) the same as the charge polarity of the toner is applied to the polarity control blade 22. When the residual toner passes through the opposed portion between the polarity control blade 22 and the photosensitive element 1, the charge is injected to the toner. Specifically, when the toner passes through the opposed portion between the polarity control blade 22 and the photosensitive element 1, the polarity control blade 22 charges the toner to normal charge polarity (negative polarity).

The toner charged to the normal charge polarity is moved to a location in which the cleaning brush 23 removes the toner from the photosensitive element 1 through movement of the surface of the photosensitive element 1. As shown in FIG. 1, a voltage (e.g., +600 volts) with the opposite polarity (positive polarity) to the charge polarity of the toner is applied to the cleaning brush 23, and the cleaning brush 23 thereby electrostatically attracts the toner having passed through the opposed portion between the polarity control blade 22 and the photosensitive element 1.

The toner having moved to the cleaning brush 23 further moves to the collecting roller 24 by means of a potential gradient, the collecting roller 24 being applied with a voltage with the positive polarity (e.g., +900 volts) higher than that of the cleaning brush 23 by a collection power supply 28. The toner having moved to the collecting roller 24 is scraped off by the collecting-roller cleaning blade 27, and is discharged by the toner discharging screw 19 to the outside of the cleaning device 20 or returned to the inside of the developing device 6.

Details how the charge polarity of the toner changes will be explained below. Specifically, the change occurs while the toner is passing through the conductive polarity control blade 22 applied with the voltage with the same polarity (negative polarity) as that of the toner.

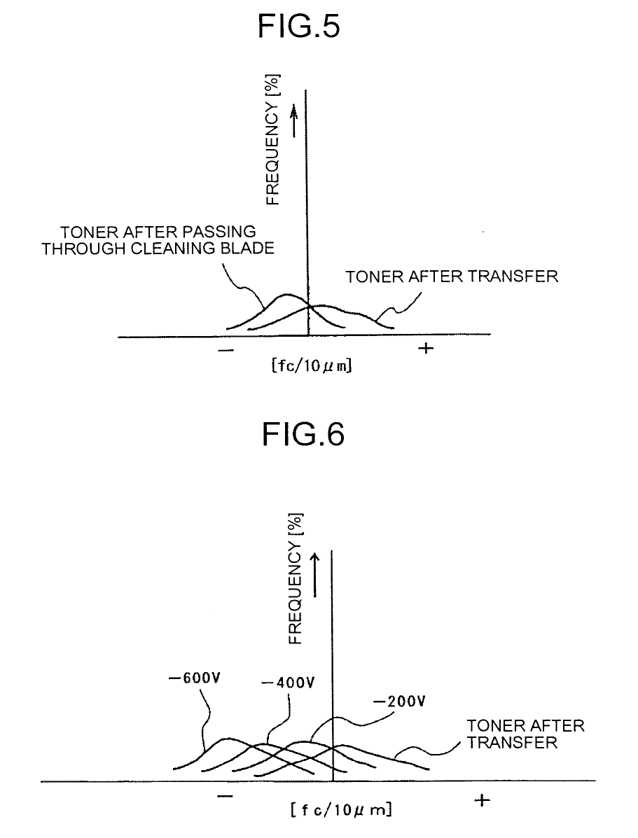

The polarity control blade 22 has an electrical resistance of 1×10⁶ Ω·cm to 1×10⁸ Ω·cm and a linear pressure at a contact portion with the photosensitive element 1 of 20 g/cm to 40 g/cm, and is configured so as to contact the photosensitive element 1 in a counter direction. If the voltage is not applied to the polarity control blade 22, the toner passing through the polarity control blade 22 is frictionally charged by pressure of the contact portion between the photosensitive element 1 and the polarity control blade 22. Then, a charge potential distribution of the toner shifts to the normal charge polarity (negative polarity) side of the toner. FIG. 5 is a graph representing a charge potential distribution of toner carried on the photosensitive element 1 after transfer thereof and a charge potential distribution of the residual toner having passed through the opposed portion to the polarity control blade 22. The toner having passed through the opposed portion to the polarity control blade 22 is slightly charged to the negative polarity, and shifts to the normal charge polarity side of the toner. Despite this, the distribution represents a mixture of the toner with the positive polarity and the toner with the negative polarity. The charge amount distribution of the residual toner is broad as shown in FIG. 5, and thus, all the residual toner particles are not always charged to the normal charge polarity.

Therefore, any measures other than frictional charge are required to change the charge polarity of all the residual toner particles to normal polarity.

Besides, as shown in FIG. 4, the so-called stick-slip occurs in such a manner that the contact state of the polarity control blade 22 with the photosensitive element 1 changes to the direction of rotation of the photosensitive element 1. When the conductive polarity control blade 22 moves to a state indicated by C of FIG. 4, then the toner passes therethrough.

As shown in FIGS. 1 and 2, if a negative voltage is applied to the polarity control blade 22 and when the toner is held between the polarity control blade 22 and the photosensitive element 1, electric current flows into the toner with the voltage applied to the polarity control blade 22. The toner is thereby charged to the polarity of the applied voltage side, to pass through the contact portion between the polarity control blade 22 and the photosensitive element 1. The toner is also charged to the polarity the same as that of the applied voltage by means of micro-discharge at a fine gap portion between an entrance and an exit of a wedge portion formed with the photosensitive element 1 and the polarity control blade 22.

FIG. 6 is a graph representing changes of a charge potential distribution (toner q/d distribution) of the residual toner when the voltage applied to the polarity control blade 22 is changed. The toner passing through the contact portion between the polarity control blade 22 and the photosensitive element 1 shifts to the normal charge polarity of the toner due to “frictional charge”, “charge injection”, “electric discharge” caused by the photosensitive element 1 and the polarity control blade 22. At this time, as shown in FIG. 6, the toner shifts to the normal charge polarity of the toner according to an increase in the voltage applied to the polarity control blade 22.

The polarity control blade 22 is an elastic body formed of a material such as polyurethane rubber and is given conductivity. The thickness thereof is in a range from 1.5 millimeters to 3 millimeters, preferably in a range from 2 millimeters to 2.5 millimeters. If the thickness is too thin, it is difficult to ensure the linear pressure of the polarity control blade 22 to the photosensitive element 1 due to distortion of the surface of the photosensitive element 1 and of the polarity control blade 22 itself. Meanwhile, if the thickness is too thick, the linear pressure to the contact depth largely changes, and control of the linear pressure becomes thereby difficult, which results in a high linear pressure with respect to a targeted linear pressure and acceleration of wear of the polarity control blade 22.

The polarity control blade 22 of the cleaning device 20 comes in contact with the photosensitive element 1 in the counter direction, and a contact angle is 20 degrees, a contact pressure is 20 g/cm, and a contact depth to the photosensitive element 1 is 1 millimeter. An electrical resistance thereof is set to 1×10⁶ Ω·cm. The electrical resistance is preferably about 2×10⁵ Ω·cm to 5×10⁷ Ω·cm.

The polarity control blade 22 is formed of a plate bonded to a blade holder 21 (sheet metal), and a thickness is 2 millimeters, a free length is 7 millimeters, a JIS-A hardness is 60 to 80, and impact resilience is 30%, however, any other values are also possible. For example, the JIS-A hardness is only in a range from 40 to 85. This is because there is no problem with slight increase or decrease in the amount of toner passing through the polarity control blade 22 caused by imperfect cleaning of the toner by the polarity control blade 22.

The cleaning device provided in an image forming apparatus older than the printer 1000 as shown in FIG. 2 will be explained below.

The image forming apparatus is required to have high resolution so as to be capable of forming higher resolution and higher definition images. One of means to achieve these requirements is to use toner with a smaller particle size. Besides that, more spherical toner is increasingly used rather than toner with an amorphous shape to improve a transfer rate. However, if the small-sized toner or the spherical toner is cleaned in the conventional blade cleaning system, the toner may easily pass through the blade due to its small size or its spherical shape, and thus a cleaning failure may occur, which causes the cleaning to be in a difficult condition.

However, image quality is increased by using the small-sized toner and the spherical toner, and thus as a usage pattern thereof, a cleanerless system or the like is proposed.

Even when the spherical toner is cleaned by the blade system, cleaning is possible if the linear pressure is set to be extremely high (specifically, linear pressure: 100 gf/cm or more), however, life of the photosensitive drum and the cleaning blade becomes extremely shorter accordingly. The life of the photosensitive element (life when the photosensitive layer is scraped to about ⅓) with an ordinary linear pressure (20 gf/cm) is about 100000 sheets if φ30, and the life of the cleaning blade (life when it is scraped and this causes a cleaning failure to occur) is about 120000 sheets.

Meanwhile, in the case of the high linear pressure (100 gf/cm), the life of the photosensitive element is about 20000 sheets, and the life of the cleaning blade is about 20000 sheets.

It is well known that the blade-cleaning performance for the spherical toner which is said excellent in transfer capability is inferior to the cleaning performance for pulverized (abnormally shaped) toner. Meanwhile, there is a brush cleaning system being a cleaning system that reduces the scrape of the surface of the photosensitive element and has reliable cleaning performance even in cleaning of the small-sized toner or the spherical toner.

This system is configured to arrange a cleaning brush so as to contact and rub the surface of the photosensitive element with the cleaning brush, arrange a collecting roller provided in contact with the cleaning brush, and remove toner from the collecting roller by means such as a rubber blade. A voltage is applied to the collecting roller, or to both the collecting roller and the brush, and cleaning is performed by means of electrostatic force, and thus the system is effective when the spherical toner is used.

Generally, in a transfer process, a voltage with opposite polarity to that of toner after developing is applied to the toner, and thus toner remaining on the photosensitive element 1 after transfer contains a mixture of toner with the same polarity as that of toner after being developed and toner charged to the opposite polarity, or uncharged toner. As means to clean the mixture of the toner with the both polarities and the uncharged toner, Japanese Patent Application Laid-Open No. 2005-265907 describes the method of controlling the charge amount of toner before being cleaned using a corotron charging system in which a voltage is applied to a corotron charger, arranging two brushes to which voltages with positive polarity and negative polarity are applied respectively, and cleaning the toner with each polarity.

As is the cleaning device described in Japanese Patent Application Laid-Open No. 2005-265907, arrangement of the two brushes opposite to a photosensitive drum and arrangement of collecting devices for toner adhering to the respective brushes are quite difficult to achieve a task of minimizing the image forming apparatus. The diameter of a photosensitive drum tends to be smaller to achieve a recent purpose of minimizing image forming apparatuses, and the cleaning device also has a task of space saving to meet the purpose. In contrast to the system having the double brushes and the collecting rollers for the respective brushes, there is a system as follows to further minimize the system. In the system, a polarity control blade applied with a voltage is arranged and an electrostatic cleaning device is arranged in the downstream side thereof, and the charge polarity of the residual toner is made uniform to one side by the polarity control blade and is cleaned by the electrostatic cleaning device.

There is a system of using two rollers provided in the electrostatic cleaning device, one of the rollers being a brush roller of which core bar is electrically floated and the other one being a low-resistance collecting roller applied with a high voltage, to form a potential difference between the two rollers, causing toner to adhere to the brush roller from an image carrier, and then collecting the toner into the collecting roller. However, this system has a problem that the potential of the cleaning brush having been floated becomes unstable, which causes the potential difference between the two rollers to become unstable, the toner is not stably collected, which causes the toner to be deposited on the brush roller as a result of use over time, the toner deposited on the brush roller re-adheres to the photosensitive element, and the cleaning performance thereby decreases.

In the cleaning device 20 provided in the printer 100 of FIG. 1 and the printer 1000 of FIG. 2, a voltage is applied to the core bar 23a of the cleaning brush 23 formed of the brush roller, and a voltage is also applied to the shaft of the collecting roller 24, to thereby stabilize the potential between the cleaning brush 23 and the collecting roller 24. Moreover, the cleaning brush 23 has conductive brush fibers each of which an inner portion is formed of a conductive material and a surface is formed of an insulating material. The conductive brush fiber is processed to be inclined, and the brush portion contacting the photosensitive element is provided as an insulated portion, so that the cleaning performance is improved.

The cleaning brush 23 in the cleaning device 20 of the printer 100 will be explained below. Specifically, the cleaning brush 23 electrostatically removes the residual toner having passed through the contact portion between the polarity control blade 22 and the photosensitive element 1.

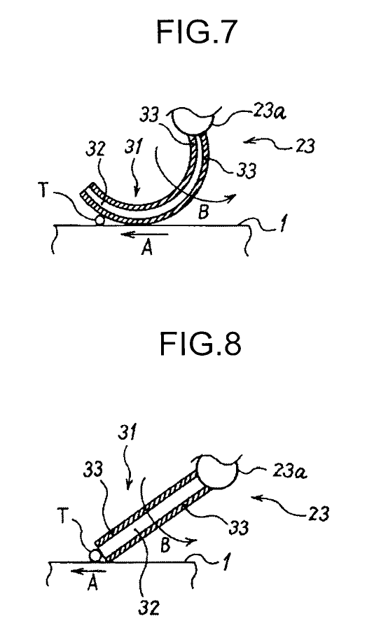

FIG. 7 is a vertical cross-section of a brush fiber 31, contacting the photosensitive element 1, of the cleaning brush 23 provided in the cleaning device 20 of the printer 100. The brush fiber 31 of the cleaning brush 23 has a double-layered core sheath structure in which the inner side thereof is made of a conductive material 32 and the surface portion thereof is made of an insulating material 33. Because the brush fiber 31 with the core sheath structure has a surface layer being the surface portion made of the insulating material 33, the conductive material 32 and the toner do not contact each other except in the cut face of the fiber. Consequently, it is possible to prevent charge injection to the toner that is removed from the cleaning brush 23.

Further, the brush fiber 31 is inclined or bent in such a manner that the fiber is bent backward in the direction (direction of arrow B in FIG. 7) of rotation of the cleaning brush 23 as shown in FIG. 7.

A case where the brush fiber 31 is straight will be explained below.

FIG. 8 is a vertical cross-section of a brush fiber 31 when it is straight, or when the brush fiber 31 having the core sheath structure formed of the inner side thereof being the conductive material 32 and the surface portion thereof being the insulating material 33 is radially fixed to the core bar 23a that is the rotating shaft of the brush. The arrow B in FIG. 8 represents a rotational direction of the cleaning brush 23 or movement direction of the brush fiber 31. If the brush fiber 31 is straight as shown in FIG. 8, the conductive material 32 and a toner particle T contact each other in the section of the tip of the brush fiber 31, and this may cause charge injection from the cleaning brush 23 to the toner.

Meanwhile, if the brush fiber 31 is inclined, as shown in FIG. 7, the conductive material 32 provided inside the brush fiber 31 hardly contact the toner particle T. With this feature, it is possible to prevent the charge injection from the cleaning brush 23 to the toner during movement of the toner from the photosensitive element 1 to the cleaning brush 23 and from the cleaning brush 23 to the collecting roller 24.

The brush fiber 31 may be formed of any material having the double-layered core sheath structure in which the inner side thereof is formed of the conductive material 32 and the surface portion thereof is formed of the insulating material 33. Typical fibers with the “core sheath structure” in which the surface is an insulator and the inner side is a conductive material are disclosed in Japanese Patent Application Laid-open Nos. H10-310974, H10-131035, H01-292116, and Japanese Patent Application Kokai Nos. H07-033637, H07-033606, H03-064604, or the like.

The material of the brush fiber is generally insulating materials such as nylon, polyester, and acryl, and all the materials have the same effect.

The structure of the collecting roller 24 of the printer 100 according to the first embodiment shown in FIG. 1 is different from that of the printer 1000 described in Japanese Patent Application No. 2006-275702 shown in FIG. 2. A metal roller made of SUS is used as the collecting roller 24 of the printer 1000. Meanwhile, the collecting roller 24 of the printer 100 is structured so as to wind a polyvinylidene fluoride (PVDF) tube around the metal core bar 23a and to further provide an insulating layer on its surface layer so as to reduce charge injection to the toner between the cleaning brush 23 and the collecting roller 24.

As explained above, if the collecting roller 24 is a roller whose surface has a resistive layer, a potential difference between the cleaning brush 23 and the collecting roller 24 is more easily increased. If the metal roller is used, the tip potential of brush fibers 31 of the cleaning brush 23 is close to an applied voltage to the collecting roller 24.

However, in this system also, if the low-resistance surface layer is used as the collecting roller 24, it is found that by increasing the voltage applied to the shaft of the collecting roller 24 so as to increase toner collection performance from the cleaning brush 23, the polarity of the toner adhering to the cleaning brush 23 is reversed and the toner with the reversed polarity re-adheres to the photosensitive element 1, and this causes the cleaning performance to be degraded.

For the problem, it is also found that by increasing the resistance of the surface layer of the collecting roller 24, re-adhesion of the toner to the photosensitive element 1 is reduced. When a voltage is discretely applied to the core bar 23a of the cleaning brush 23 and to the shaft of the collecting roller 24, a high resistive layer is used as the surface layer of the collecting roller 24 so that a surface resistivity is 1×10¹⁰ Ω/cm² or more or a roller resistance is 1×10¹⁰Ω or more in a measurement method A shown below. By using the collecting roller 24 as explained above, it is resulted that the polarity of the toner held between the brush fibers 31 and the collecting roller 24 is difficult to be reversed as compared with the case of using a roller with a metal surface.

More specifically, the residual toner having passed through the transfer process and before being cleaned passes through the contact portion between the polarity control blade 22 and the photosensitive element 1, and is controlled to have the negative polarity. Moreover, a positive polarity voltage V1 is applied to the core bar 23a of the cleaning brush 23. Specifically, the positive polarity voltage V1 is set so that the tip potential of the cleaning brush 23 is higher than the surface potential of the photosensitive element 1 in the downstream side of the contact portion between the polarity control blade 22 and the photosensitive element 1 in the movement direction of the surface of the photosensitive element 1. A positive polarity voltage V2 is applied also to the shaft of the collecting roller 24 (V2>V1). Based on the configuration, the toner controlled to the negative polarity by the polarity control blade 22 is collected by adhering to the cleaning brush 23 with a slightly positive polarity and then adhering to the high-voltage collecting roller with a more positive polarity than that of the cleaning brush 23. At this time, if the surface of the collecting roller 24 is metal or a low resistive layer, it is resulted that the polarity of the toner held between the brush fibers 31 and the collecting roller 24 is easily reversed.

When the polarity of the toner adhering to the cleaning brush 23 is reversed, the toner has the positive polarity and adheres to the cleaning brush 23 with a lower voltage than that of the collecting roller 24 even with the same positive polarity. Consequently, the positive polarity toner exists in the cleaning brush 23, and because the surface potential of the photosensitive element 1 is in the negative polarity side than the tip potential of the cleaning brush 23, the toner adheres to the photosensitive element 1 from the cleaning brush 23, which causes a cleaning failure, and the toner is output from the cleaning device 20. This causes failure such as contamination of a charger.

Meanwhile, when the surface of the collecting roller 24 has a high resistive layer, the polarity of the toner held between the brush fibers 31 and the collecting roller 24 is difficult to be reversed, and as a result, a cleaning failure due to the toner with the reversed polarity is difficult to occur.

The measurement method A is explained below.

Resistance of the collecting roller was measured by using a UA probe of Hiresta UP manufactured by Dia Instruments Co., Ltd. in such a manner that a grounded metal electrode and the roller shaft were connected by a conductor wire, one of two electrodes of the probe was caused to contact the roller surface and the other electrode was caused to contact the grounded metal electrode, and an electrical resistance (Ω) was determined from a current when a predetermined voltage was applied 10 seconds. The predetermined voltage was 500 volts in an environment of 32° C. and 80%, and was 1000 volts in an environment of 10° C. and 15%.

As explained above, it is found that this configuration has an advantage that when the surface of the collecting roller 24 has the high resistive layer (1×10¹⁰ Ω·cm or more) or has the insulating layer, the polarity of the toner held between the brush fibers 31 and the collecting roller 24 is difficult to be reversed, however, the following failure will occur.

More specifically, a surface potential V4 of the collecting roller 24 is measured after the toner having adhered to the surface of the collecting roller 24 is cleaned by the collecting-roller cleaning blade 27, and it is thereby found that the surface potential V4 decreases with increasing amount of toner adhesion per unit area. It is also found that a tip potential V3 of the cleaning brush 23 rotating while contacting the collecting roller 24 also decreases.

When the surface potential V4 of the collecting roller 24 decreases, the performance of the collecting roller 24 that removes the toner from the cleaning brush 23 decreases, and the toner adhering to the cleaning brush 23 is not collected by the collecting roller 24, so that the toner may pass through the contact portion between the cleaning brush 23 and the collecting roller 24. If the toner adhering to the cleaning brush 23 passes through the contact portion therebetween, the toner reaches the contact portion between the cleaning brush 23 and the photosensitive element 1, and re-adheres to the photosensitive element 1, which may cause a cleaning failure.

As explained above, if the tip potential V3 of the cleaning brush 23 decreases, the performance of the cleaning brush 23 that removes the toner from the photosensitive element 1 decreases, and the toner cannot perfectly be removed from the surface of the photosensitive element 1, which may cause a cleaning failure.

The reasons that the surface potential V4 of the collecting roller 24 and the tip potential V3 of the cleaning brush 23 decrease are not apparent, however, the followings are thought as factors.

When the charged toner adhering to the surface of the collecting roller 24 is scraped off by the collecting-roller cleaning blade 27, peel discharge occurs, and charge with the negative polarity is imparted to the high resistive layer or to the insulating layer, which may cause the surface potential V4 to decrease. Alternatively, charge with the negative polarity is imparted from the toner to the surface layer of the collecting roller 24 due to toner adhesion, and even if the toner is scraped off by the collecting-roller cleaning blade 27, the charge imparted from the toner remains on the surface layer, which may cause the surface potential V4 to decrease.

A characteristic portion of the first embodiment will be explained below.

As explained above, when the toner moves from the cleaning brush 23 to the collecting roller 24, the tip potential of the brush decreases. Therefore, the cleaning device 20 according to the first embodiment includes the cleaning-brush charge imparting unit 39 of metal (made of SUS) arranged so as to contact the surface of the cleaning brush 23 after the cleaning brush 23 contacts the collecting roller 24 as shown in FIG. 1. The cleaning device 20 also includes a brush-charge imparting power supply 34 being a brush-charge-imparting-unit voltage applying unit that applies a voltage to the cleaning-brush charge imparting unit 39. In the first embodiment, a voltage with the same level as that of the core bar 23a of the cleaning brush 23 is applied to the cleaning-brush charge imparting unit 39. A voltage of 700 volts is applied from the brush power supply 30 to the core bar 23a of the cleaning brush 23, and a voltage of 700 volts is applied from the brush-charge imparting power supply 34 to the cleaning-brush charge imparting unit 39.

The cleaning device 20 according to the first embodiment includes the cleaning-brush charge imparting unit 39, and this allows prevention of decrease in the tip potential of the brush that occurs upon removal of the toner from the cleaning brush 23, so that the tip potential of the cleaning brush 23 is maintained. As a result, the tip potential of the cleaning brush 23 that directly contacts and rubs the photosensitive element 1 therewith can be kept to a potential at which the toner on the photosensitive element 1 can be satisfactorily cleaned. With this feature, the cleaning can be stably performed over time.

A power supply that applies a voltage to the cleaning-brush charge imparting unit 39 is not limited to a configuration in which the power supply is provided independently from the brush power supply 30. Thus, it may be a configuration to apply a voltage of the same magnitude as that of the voltage applied to the core bar 23a thereto from the brush power supply 30.

A voltage higher than a shaft voltage of the collecting roller 24 is also applied to the collecting-roller cleaning blade 27 because the surface potential of the collecting roller 24 decreases when the toner is scraped off from the surface of the collecting roller 24 similarly to the cleaning brush 23. When the surface potential of the collecting roller 24 decreases, a potential difference between the cleaning brush 23 and the collecting roller 24 decreases, movement of the toner decreases, the toner is gradually deposited on the cleaning brush 23, and the removal performance of the toner from the photosensitive element 1 thereby decreases.

The cleaning performance of the cleaning device 20 will be examined using three examples, the conventional example shown in FIG. 2, a comparative example in which the configuration of the blade is different from that according to the first embodiment shown in FIG. 1, and a present example which is the configuration according to the first embodiment shown in FIG. 1.

Specific configurations of the cleaning brush 23, the collecting roller 24, and the collecting-roller cleaning blade 27 according to the conventional example, the comparative example, and the present example are shown in Table 1

TABLE 1

| | Conventional | Comparative | Present |
|---|---|---|---|
| | example | example | example |
| Material of core | SUS | SUS | SUS |
| bar of | | | |
| collecting | | | |
| roller | | | |

| Surface material | SUS | Acrylic UV cured resin layer |
|---|---|---|
| of collecting | | (thickness: 3 μm to 5 μm) |
| roller | | provided on surface layer of |
| | | PVDF (thickness: 100 μm) |
| Resistance of | | 1 × 10¹² Ω to 1 × 10¹³ Ω (at 32° C., |
| collecting | | 80%), 1 × 10¹³ Ω (at 10° C., 15%) |
| roller | | |
| (Measuring | | |
| method is shown | | |
| in Note 1) | | |
| Material of | Conductive polyester (inner side of fiber: | |
| cleaning brush | conductive carbon, surface of fiber: | |
| | polyester) | |
| Conditions of | Resistance of brush original yarn: 10⁸ Ω · cm | |
| cleaning brush | Filling density of brush fibers: 100000 | |
| | lines/inch² | |
| | Diameter of brush fiber: about 25 μm to 35 μm | |
| | Brush fibers processed to be bent | |
| Contact depth of | 1 mm | |
| cleaning brush | | |
| fiber to | | |
| photosensitive | | |
| drum | | |
| Contact depth of | 1 mm | |
| cleaning brush | | |
| fiber to | | |
| collecting | | |
| roller | | |
| Material of | Polyurethane | Conductive-carbon containing |
| collecting- | rubber | polyurethane rubber |
| roller cleaning | | Volume resistivity: 10⁶ Ω · cm |
| blade | | (at 25° C. and 50%) |

| | |
|---|---|
| Conditions of | Blade contact angle: 20°, blade thickness: |
| collecting- | 2.8 mm, contact depth of blade to collecting |
| roller cleaning | roller: 0.6 mm |
| blade | |

Note 1:
Resistance of the collecting roller 24 is measured by using a UA probe of Hiresta UP manufactured by Dia Instruments Co., Ltd. in such a manner that the roller shaft and a metal electrode are connected by a conductor wire, one of two electrodes of the probe is caused to contact the roller surface and the other electrode is caused to contact the grounded metal electrode, and an electrical resistance (Ω) is determined from a current when a predetermined voltage is applied 10 seconds. The predetermined voltage is 500 volts in an environment of 32° C. and 80%, and is 1000 volts in an environment of 10° C. and 15%.

If the collecting roller 24 is a roller whose surface has a resistive layer, a potential difference between the cleaning brush 23 and the collecting roller 24 is more easily increased.

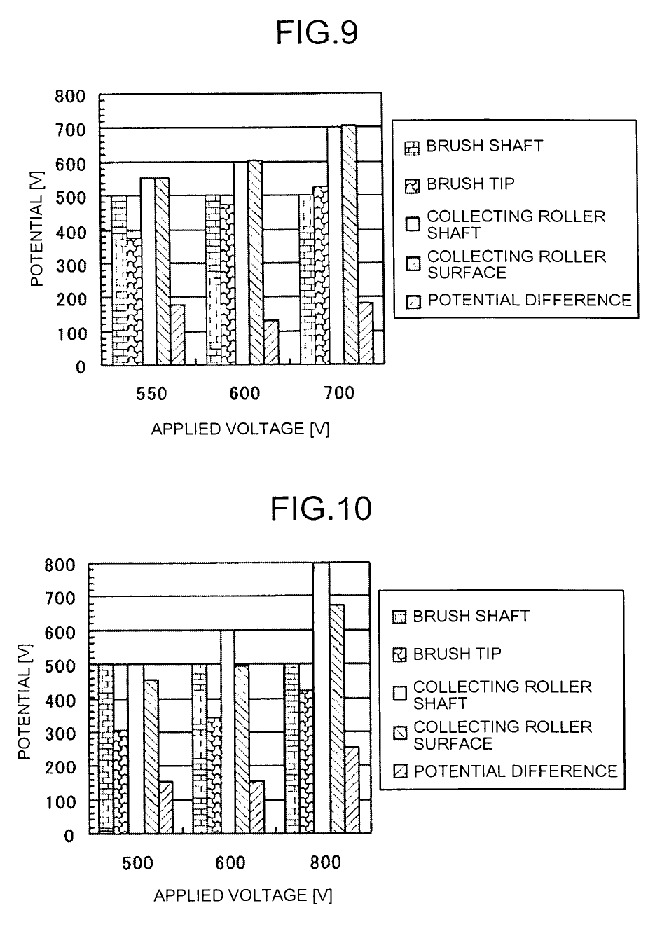

This configuration will be explained below with reference to FIGS. 9 and 10.

FIG. 9 is a graph representing a shaft potential of the cleaning brush 23, a tip potential of the cleaning brush 23, a shaft potential of the collecting roller 24, a surface potential of the collecting roller 24, and each potential difference (the surface potential of the collecting roller 24—the tip potential of the cleaning brush 23) using the SUS-made collecting roller 24 used in the conventional example in an environment of 32° C. and 80%, when a voltage of 500 is applied to the core bar 23a of the cleaning brush 23 and a voltage of 550 volts to 700 volts is applied to the shaft of the collecting roller 24.

FIG. 10 is a graph representing a shaft potential of the cleaning brush 23, a tip potential of the cleaning brush 23, a shaft potential of the collecting roller 24, a surface potential of the collecting roller 24, and each potential difference (the surface potential of the collecting roller 24—the tip potential of the cleaning brush 23) using the collecting roller 24 used in the comparative example in an environment of 32° C. and 80%, when a voltage of 500 volts is applied to the core bar 23a of the cleaning brush 23 and a voltage of 500 volts to 800 volts is applied to the shaft of the collecting roller 24.

By using the metal roller as shown in the conventional example, the tip potential of the cleaning brush 23 is close to the surface potential of the collecting roller 24, and thus, even if an applied voltage to the shaft of the collecting roller 24 is increased, a potential difference between the surfaces of the two elements is not increased.

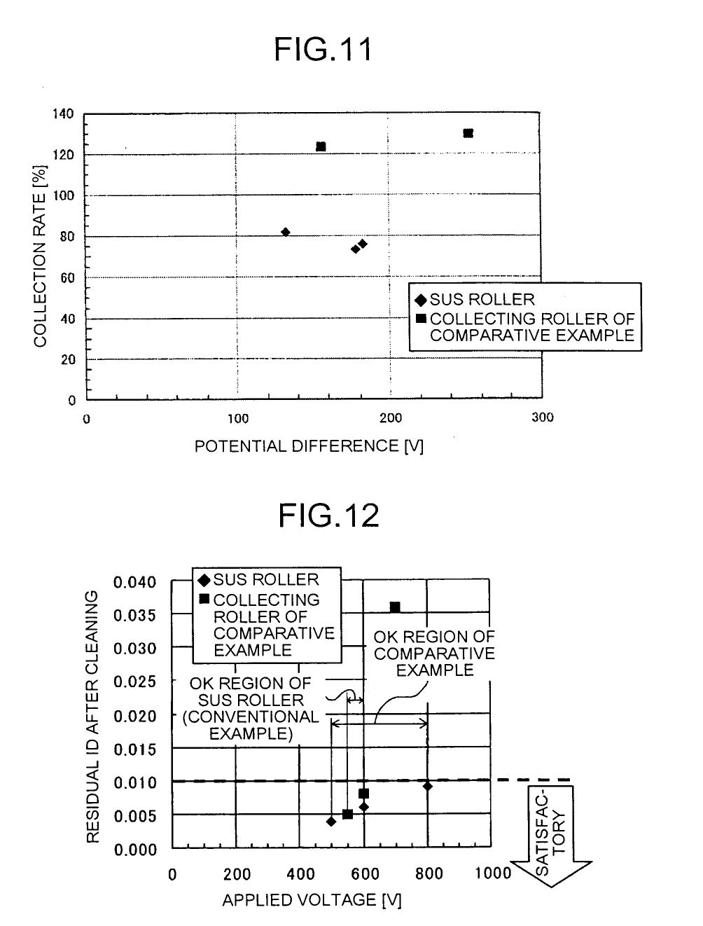

FIG. 11 is a graph in which a potential difference between a tip potential of the cleaning brush 23 and a surface potential of the collecting roller 24 is plotted on the horizontal axis, and a collection rate is plotted on the vertical axis. The collection rate mentioned here is obtained by causing an experimentally known amount of toner (an amount of toner (mg/cm²) per unit area is used so as to be easily calculated) to adhere to the photosensitive element, measuring an amount of toner (an amount of toner per unit area) collected by the collecting roller 24 after the toner is cleaned by the cleaning brush 23, and calculating collection rate (%)=(M/A on the collecting roller 24)/(M/A of toner input to the cleaning brush 23)×100 (where M/A: the mass of toner per unit area [mg/cm²]).

As is clear from FIG. 11, when the SUS roller is used, the collection rate is about 80%, while when the roller of the comparative example is used, the collection rate is 100% or more. The reason that the collection rate exceeds 100% is as follows. Specifically, because toner is input for 10 seconds, the toner cannot be perfectly collected (100%) for initial several seconds through each rotation of the cleaning brush 23 and the collecting roller 24, and the toner is thereby deposited on the cleaning brush 23. Then, the collecting roller 24 collects an amount of tens of percents of a total amount of the toner, toner that is deposited next, and toner that is successively input, and thus, the amount of collection may sometimes exceed the amount of input.

According to FIGS. 9, 10, and 11, the followings become apparent. More specifically, even if the voltage applied to the shaft of the collecting roller 24 is increased to improve the toner collection performance from the cleaning brush 23, the toner collection performance is not improved in the case of the SUS roller. Meanwhile, when the applied voltage to the shaft of the collecting roller 24 is increased by using the roller shown in the comparative example, the potential difference with the tip of the cleaning brush 23 increases, the toner collection performance by the collecting roller 24 is thereby improved. Therefore, to increase the toner collection performance, a high resistance roller is more appropriate than the SUS roller.

A second advantage of the configuration according to the comparative example will be explained below, in addition to the advantage of the comparative example as compared with the conventional example explained with reference to FIGS. 9 to 11.

The cleaning performance on the photosensitive element 1 is improved by using the collecting roller 24 of the comparative example, as compared to the case of using the SUS roller. The results are shown in FIG. 12.

The “residual ID after cleaning” plotted on the vertical axis of FIG. 12 represents a following index. The residual ID after cleaning is a value obtained by subtracting a second image density (ID) from a first image density (ID). More specifically, the first ID is a total value of toner, a piece of tape, and a white paper, obtained by transferring the toner on the photosensitive element 1 after being cleaned by the cleaning brush 23 to the piece of tape using Scotch tape, taping the piece of tape with the toner thereon on the white paper, and measuring it using Spectrodensitometer (X-Rite 938), while by taping only a piece of tape on the same white paper using Scotch tape and measuring it by the Spectrodensitometer. The second ID is a total value of a piece of tape and a white paper on which the piece of tape is taped using Scotch tape. The ID and the number of toner particles have a correlation, and the value of ID increases as the number of toner particles increases. Therefore, it is possible to determine based on the ID whether the cleaning performance is appropriate. In other words, the index indicates that cleaning performance is better with a smaller value of the residual ID after cleaning.

As compared with the SUS roller, the roller of the comparative example has a large degree of allowance of the applied voltage with respect to the residual ID after cleaning when the applied voltage to the collecting roller 24 is increased, and the cleaning performance is satisfactorily maintained even when the applied voltage is increased.

The inventors of the present invention think the reason of this as follows.

A positive polarity voltage V1 is set so that the tip potential of the cleaning brush 23 is higher than the surface potential of the toner after passing through the polarity control blade 22, the toner before being cleaned passing through the polarity control blade 22 via the transfer process and being controlled to the negative polarity. The positive polarity voltage V1 set in the above manner is applied to the shaft of the cleaning brush 23. Further, when a positive polarity voltage V2 (V2>V1) is applied to the shaft of the collecting roller 24, the toner with the negative polarity adheres to the cleaning brush 23 with slight positive polarity, then adheres to the high-voltage collecting roller 24 with more positive polarity than the cleaning brush 23, and is collected. However, if the surface of the collecting roller 24 is metal and when the collecting roller 24 contacts the toner adhering to the brush fibers 31 of the cleaning brush 23, the charge is continued to be supplied until when the potential of the toner becomes the same as that of the surface of the collecting roller 24. The speed of the supply is assumed faster than the time from when a high-resistance surface material gives charge to the cleaning brush 23 and the toner until when the surface material is again supplied with power from the power supply and the potential thereof becomes the same as that of the surface of the collecting roller 24.

Because of this, the SUS-made collecting roller 24 more easily reverses the polarity of the toner adhering to the cleaning brush 23, and when the polarity is reversed, the toner becomes the positive polarity and adheres to the cleaning brush 23 with a lower voltage than that of the collecting roller 24 even with the same positive polarity. Resultantly, the toner with the positive polarity exists on the cleaning brush 23. Because the potential of the photosensitive element 1 is in the negative polarity side than the tip potential of the cleaning brush 23, the toner moves from the cleaning brush 23 to the photosensitive element 1 to cause a cleaning failure, and is output from the cleaning device 20. This causes failure such as contamination of a charger or the like.

Meanwhile, when the surface of the collecting roller 24 is a high resistive layer of 1×10¹⁰Ω or more, the toner held between the brush fibers and the collecting roller 24 is difficult to be reversed in polarity, and as a result, a cleaning failure due to the toner with reversed polarity is difficult to occur.

As explained above, in a high-temperature and high-humidity environment, the comparative example has the advantage that the polarity of the toner held between the brush fibers and the collecting roller 24 is difficult to be reversed when the surface of the collecting roller 24 is provided with the high resistive layer (1×10¹⁰ Ω/cm² or more) or with the insulating layer.

Decrease of the tip potential of the cleaning brush 23 and decrease of the surface potential of the collecting roller 24 will be explained below. It is found that the configuration of the comparative example has some failures as explained below in a low-temperature and low-humidity environment.

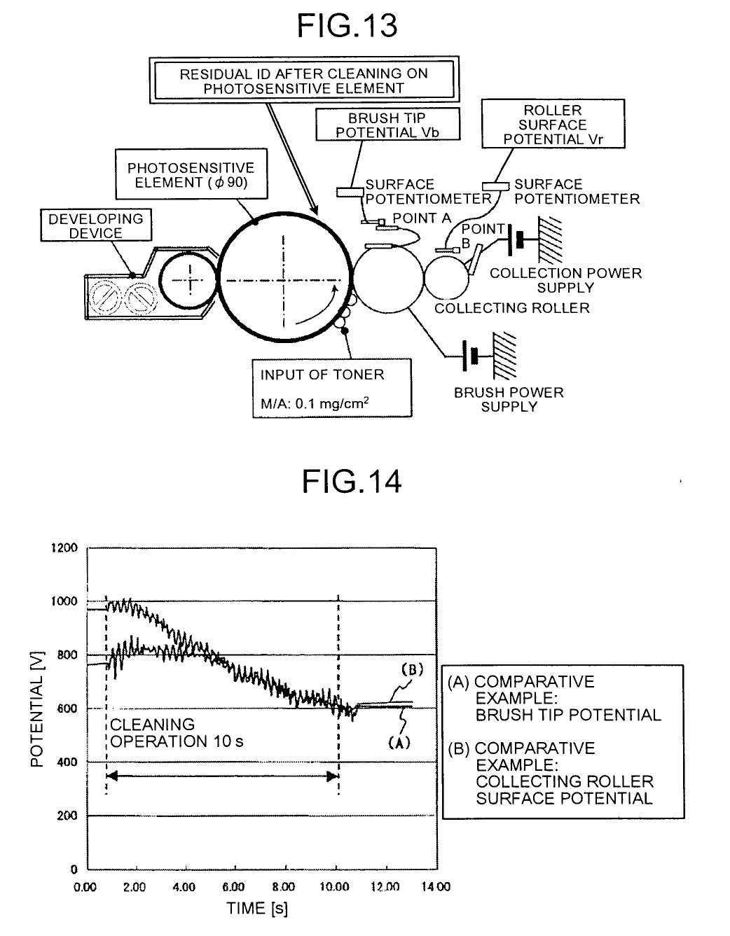

FIG. 13 is a schematic for explaining an experimental apparatus.

Experiments were conducted by the experimental apparatus shown in FIG. 13 in the low-temperature and low-humidity environment (10° C., 15%). After the toner adhered to the surface of the collecting roller 24 and was cleaned by the collecting-roller cleaning blade 27, the surface potential of the collecting roller 24 was measured at point B of FIG. 13. As a result of the measurement, it is found that the surface potential of the collecting roller 24 decreases. At the same time, the tip potential of the cleaning brush 23 rotating while contacting the collecting roller 24 was measured at point A using a surface potentiometer. Consequently, it is found that the tip potential of the cleaning brush 23 also fluctuates by hundreds of volts.

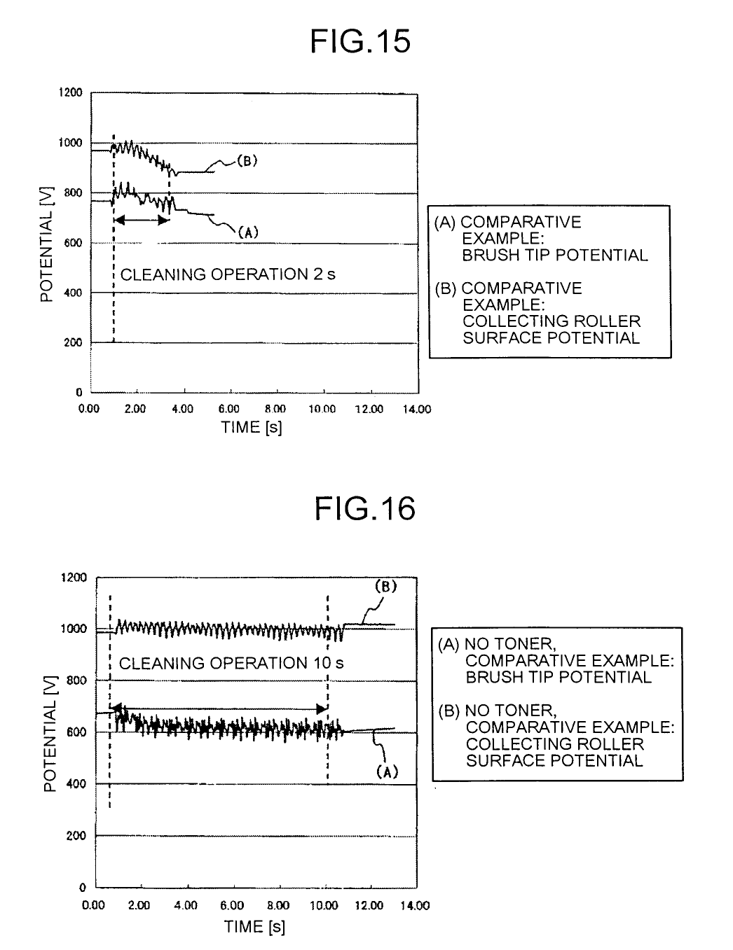

FIGS. 14, 15, and 16 represent results of measuring the surface potential of the collecting roller 24 and the tip potential of the cleaning brush 23 while inputting toner thereto using the surface potentiometer. FIG. 14 is an example of measuring the potentials for 10 seconds in which the potentials of the two decreased to such a level that there is almost no potential difference. FIG. 15 is an example of measuring the potentials for 2 seconds in which there is still a potential difference of about 150 volts although the voltages start decreasing. FIG. 16 is an example of measuring the potentials for 10 seconds without inputting toner, however, no decrease of the potentials is found. The M/A of the input toner to the photosensitive element 1 at this time was 0.1 mg/cm², and Q/M (a charge amount per unit mass) was −5 μC/g to −11 μC/g.

Generally, although the amount of the residual toner remaining on the photosensitive element 1 after the toner image is transferred fluctuates, the fluctuation is estimated as about 0.02 mg/cm² to 0.08 mg/cm², and thus, the present condition is set so as to slightly exceed the range.

Factors of decrease in the tip potential of the cleaning brush 23 and in the surface potential of the collecting roller 24 are not clear yet, however, because the decrease of the potential has a correlation with presence or absence of toner and the amount of M/A of the toner, transfer of the toner may certainly affect the decrease of the potentials.

It is now thought that when the charged toner adhering to the surface of the collecting roller 24 is scraped off by the collecting-roller cleaning blade 27, peel discharge occurs, a charge with the negative polarity is given to the high resistive layer or to the insulating layer, or a charge with the negative polarity is given to the surface layer of the collecting roller 24 due to toner adhesion and even if the toner is scraped off by the collecting-roller cleaning blade 27, the charge given from the toner remains on the surface layer.

The configuration of a present example of taking measures against the decrease of the potential of the collecting roller 24 will be explained below.

When there is no potential difference between the both components as shown in FIG. 14, the toner naturally cannot move and is deposited more and more on the cleaning brush 23, and the cleaning performance of the photosensitive element is thereby degraded. Therefore, to give a charge to the surface of the collecting roller 24, in the cleaning device 20 according to the first embodiment, a polyurethane rubber blade was replaced with a conductive one, a voltage was applied to the collecting-roller cleaning blade 27 by a roller-cleaning-blade power supply 42 being a collecting-roller cleaning-voltage applying unit as shown in FIG. 1, to increase the surface potential of the collecting roller 24.

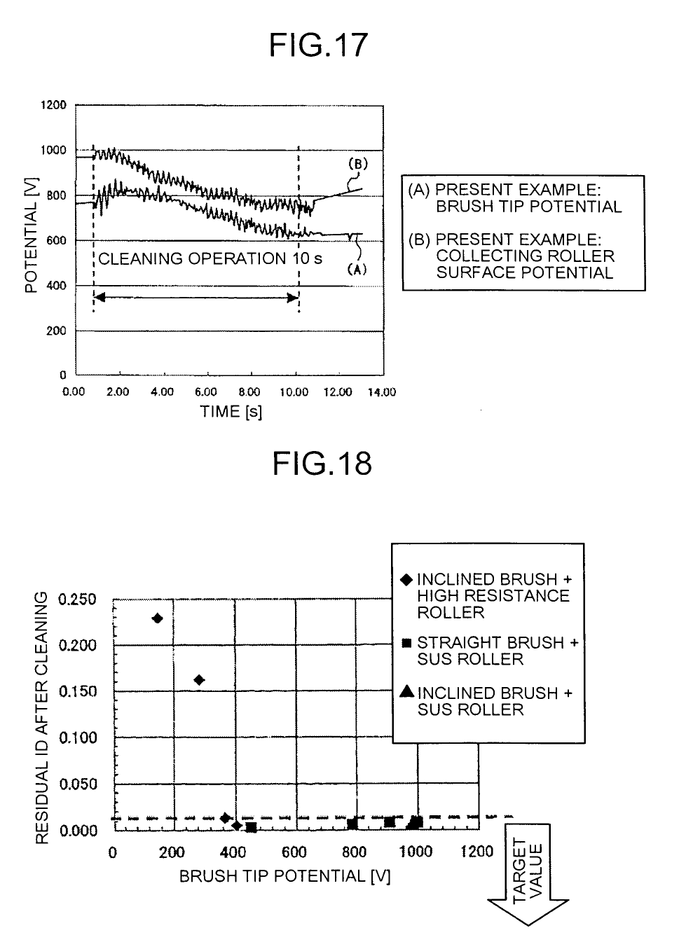

A voltage of 700 volts was applied to the core bar 23a of the cleaning brush 23, a voltage of 1000 volts was applied to the shaft of the collecting roller 24, and a voltage of 1000 volts was applied to the collecting-roller cleaning blade 27. Based on the above conditions, FIG. 17 represents the results of measuring the surface potential of the collecting roller 24 and the tip potential of the cleaning brush 23 while inputting toner thereto using the surface potentiometer.

As shown in FIG. 17, the surface potential of the collecting roller 24 increased, and a potential difference between the tip potential of the cleaning brush 23 and the surface potential of the collecting roller 24 increased more than the graph shown in FIG. 14. By decreasing the resistance of the collecting-roller cleaning blade 27 to low resistance or by increasing the applied voltage to the collecting-roller cleaning blade 27, the surface potential of the collecting roller 24 can further be increased and kept to a fixed value.

Measures taken against the fluctuation of the tip potential of the cleaning brush 23 will be explained below.

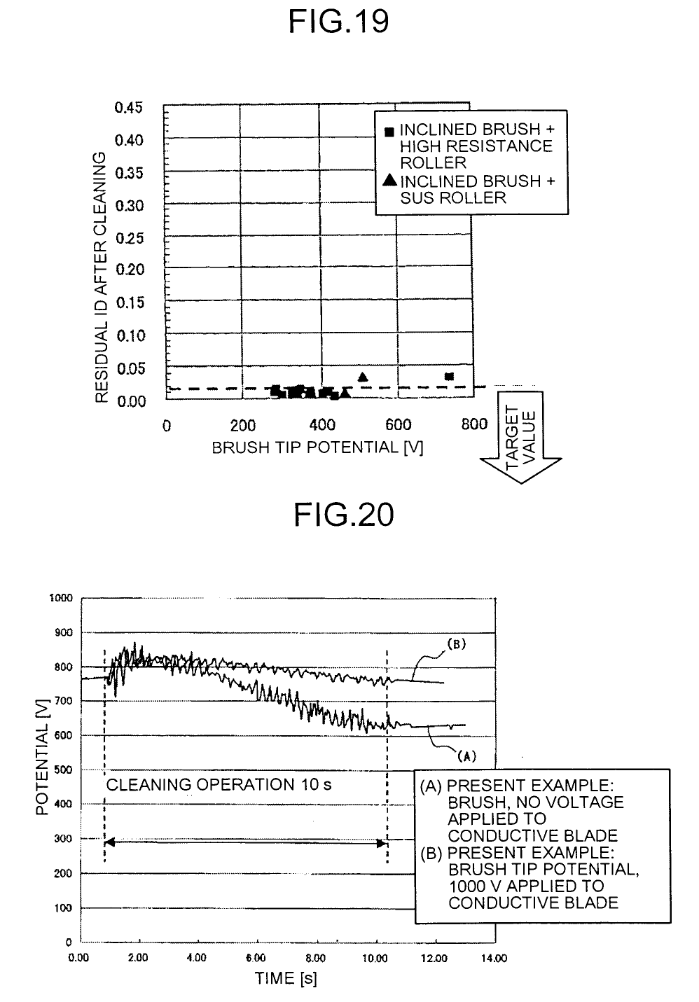

A relationship between the tip potential of the cleaning brush 23 and the residual ID after cleaning on the photosensitive element 1 is as shown in FIGS. 18 and 19. The residual ID after cleaning decreases to 0.01 or less as a target value with 400 volts to 1000 volts in an environment of 10° C. and 15%, which is satisfactory, and it is also a satisfactory value with 300 volts to 500 volts in an environment of 32° C. and 80%.

Therefore, the tip potential of the cleaning brush 23 excellent in cleaning performance is 400 volts to 500 volts even in low temperature and low humidity and even in high temperature and high humidity.

However, as explained above, in the case of the roller according to the comparative example, if a time from start of cleaning operation to its finish in the low temperature and low humidity environment requires 2 seconds or more, the tip potential of the cleaning brush 23 fluctuates (fluctuation in a range of about 250 volts) (see FIG. 14).

As measures to keep the tip potential of the cleaning brush 23 constant in the cleaning device 20 shown in FIG. 1, a system of controlling a potential of the cleaning brush 23 is used. The system is implemented by collecting the toner that adheres to the cleaning brush 23 by the collecting roller 24, giving a charge to the tip of the cleaning brush 23, and controlling the potential of the cleaning brush 23 that contributes to cleaning of the toner on the photosensitive element 1.

As shown in FIG. 1, the cleaning device 20 includes the cleaning-brush charge imparting unit 39 that is formed into a bar shape extending in the axial direction so as to contact the tip of the cleaning brush 23 after the cleaning brush 23 and the collecting roller 24 come in contact with each other. A voltage with the same polarity as that of the applied voltage applied from the brush power supply 30 to the core bar 23a of the cleaning brush 23 is applied from the brush-charge imparting power supply 34 to the cleaning-brush charge imparting unit 39. In the cleaning device 20, a stainless bar is arranged in a location in which the bar is pressed into the brush fibers 31 of the cleaning brush 23 by 1 millimeter from the tips of the brush fibers 31 in the direction of the rotating shaft of the cleaning brush 23, and 700 volts is applied from the brush-charge imparting power supply 34 to the bar.

The cleaning-brush charge imparting unit 39 is not limited to the stainless one, and thus it may be any conductive element. Further, the shape is not limited to the bar shape, and thus it may be a plate shaped one.

The power supply that applies the voltage to the cleaning-brush charge imparting unit 39 is not limited to the configuration to provide the power supply independently from the brush power supply 30 that applies the voltage to the core bar 23a, and thus it may be configured to apply a voltage to the cleaning-brush charge imparting unit 39, the voltage being the same magnitude as the voltage applied from the brush power supply 30 to the core bar 23a.

Fluctuation of the tip potential of the brush when the measures are taken against the fluctuation of the tip potential of the cleaning brush 23 is shown in FIG. 20.

In the configuration in which the measures are not taken against the fluctuation of the tip potential of the cleaning brush 23, as shown in FIG. 14, the potential continuously decreases until after 10 seconds from the end of the cleaning operation. In contrast, the tip potential of the cleaning brush 23 when 700 volts is applied to the cleaning-brush charge imparting unit 39 is prevented from decreasing as shown in FIG. 20.

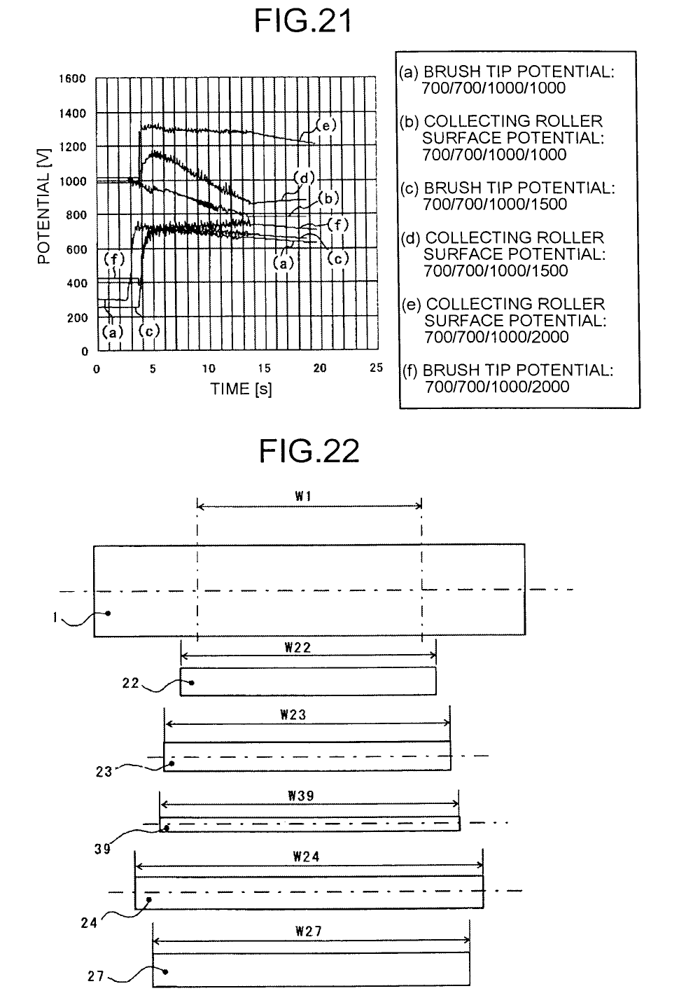

FIG. 21 is a graph representing tip potentials of the brush when an applied voltage to the collecting-roller cleaning blade 27 is increased to 1000 volts, 1500 volts, and 2000 volts in the configuration in which measures are taken against the fluctuation of the tip potential of the brush. It is found that fluctuation of the tip potential of the cleaning brush 23 decreases even when the applied voltage to the collecting-roller cleaning blade 27 is increased.

In the apparatus used in the explanation, a volume resistivity of the collecting-roller cleaning blade 27 is 1×108 Ω·cm, however, an effect due to imparting of the charge increases by selecting a low-resistance blade material in a range of causing the cleaning performance of the toner on the collecting roller 24 not to be decreased. It is desirable to select a blade material so that a resistance of the collecting-roller cleaning blade 27 does not increase particularly at low temperature and low humidity although there is not much problem with high temperature and high humidity.

As shown in FIG. 7, it is thought that even if the brush fiber 31 of the cleaning brush 23 has the core sheath structure and is inclined in the rotational direction, the surface potential of the fiber decreases and the tip potential of the brush thereby decreases because the toner on the photosensitive element 1 is moved by means of an electric field between the internally provided conductive material 32 of the brush fiber 31 and the photosensitive element 1 through the insulating material 33 of the surface portion of the brush fiber 31, and by means of an electric field between the conductive material 32 and the surface potential of the collecting roller 24.

Specifically, in the cleaning brush 23 of which each fiber whose surface portion is formed of uniformly dispersed conductive material is straight or inclined, the surface potential of the fiber does not decrease. Therefore, the decrease in the surface potential of the fiber occurs only in a combination of an inclined brush made of fibers with the core sheath structure with the high-resistance or insulated collecting roller, as is the cleaning device 20 according to the first embodiment.

Further, a voltage with opposite polarity to the above-mentioned configuration may be applied to the polarity control blade 22, the cleaning brush 23, the collecting roller 24, and the collecting-roller cleaning blade 27 of the cleaning device 20 as shown in FIGS. 1 and 2. More specifically, a voltage with the positive polarity is applied to the polarity control blade 22, and a voltage with the negative polarity is applied to the cleaning brush 23, the collecting roller 24, and the collecting-roller cleaning blade 27. In this case, the voltage with the negative polarity which is the opposite polarity to that of the configuration is also applied to the cleaning-brush charge imparting unit 39. By applying the positive polarity voltage to the polarity control blade 22, charged polarities of the residual toner particles passing through the contact portion between the surface of the photosensitive element 1 and the polarity control blade 22 are made uniform to the positive polarity. The toner particles with the uniform positive polarity are removed from the surface of the photosensitive element 1 by the cleaning brush 23, the collecting roller 24, and the collecting-roller cleaning blade 27 which are applied with the negative polarity voltage.

In the cleaning device 20 according to the first embodiment of FIG. 1, even if the tip potential of the brush fibers decreases by transferring the toner from the cleaning brush 23 to the collecting roller 24, the cleaning-brush charge imparting unit 39 can recover the tip potential of the brush fibers to the potential of the cleaning-brush charge imparting unit 39. Thus, a cleaning failure caused by the decrease in the tip potential of the brush fibers can be prevented.

A relationship among lengths of the cleaning brush 23, the cleaning-brush charge imparting unit 39, the collecting roller 24, and the collecting-roller cleaning blade 27 in their shaft direction will be explained below.

If the length of the cleaning-brush charge imparting unit 39 is shorter than the length of the cleaning brush 23 in the direction of the rotating shaft, some brush fibers may not contact the cleaning-brush charge imparting unit 39. When the potential of the surface portion of the brush fibers incapable of contacting the cleaning-brush charge imparting unit 39 decreases, this leads to a cleaning failure of the surface of the photosensitive element 1 in portions with which the brush fibers come in contact.

To solve the problem, in the cleaning device 20 according to the first embodiment, the length of the cleaning-brush charge imparting unit 39 is set to the length or more of the cleaning brush 23 in the direction of the rotating shaft of the cleaning brush 23. With this feature, the cleaning-brush charge imparting unit 39 comes in contact with the entire area of the tips of the cleaning brush 23 in the shaft direction after the collecting roller 24 is in contact therewith. Therefore, all the brush fibers can come in contact with the cleaning-brush charge imparting unit 39 by passing through the contact portion with the cleaning-brush charge imparting unit 39 through rotation of the cleaning brush 23. Thus, even any brush fiber of the cleaning brush 23 can be recovered to a predetermined potential after the potential decreases due to transfer of the toner to the collecting roller 24 which is the brush-roller cleaning unit.

As explained above, any brush fiber can be recovered to the predetermined potential by coming in contact with the cleaning-brush charge imparting unit 39 after the potential decreases due to transfer of the toner to the collecting roller 24, thus more reliable and satisfactory cleaning can be achieved.

FIG. 22 is a schematic indicative of a relationship among lengths of the photosensitive element 1, the polarity control blade 22, the cleaning brush 23, the cleaning-brush charge imparting unit 39, the collecting roller 24, and the collecting-roller cleaning blade 27 in the shaft direction of the photosensitive element 1.

First, a toner image is developed on the photosensitive element in a width wider than an image area W1 (toner causing background soils adheres to any area other than the image area). Then, when the toner passes through the transfer process, the polarities of the residual toner particles remaining on the photosensitive element 1 without being transferred are made uniform to one polarity by the polarity control blade 22 with a width (W22) wider than a development area (image area) W1 as shown in FIG. 22. The residual toner particles with the polarities made to the one polarity are removed from the photosensitive element 1 by the cleaning brush 23 with a width (W23) wider than the width (W22) of the polarity control blade 22.

The toner having moved to the cleaning brush 23 is moved to the collecting roller 24 by means of a potential gradient with the collecting roller 24. The width (W24) of the collecting roller 24 is set wider than the width (W23) of the cleaning brush 23. The collecting-roller cleaning blade 27 has two functions, and one of them is a function of mechanically scraping off the toner on the collecting roller 24, and therefore the width (W24) of the collecting roller 24 has to be wider than the width (W23) of the cleaning brush 23. Meanwhile, the collecting-roller cleaning blade 27 is pressed against the collecting roller 24, and thus if the width (W27) of the collecting-roller cleaning blade 27 is set wider than the width (W24) of the collecting roller 24, the collecting-roller cleaning blade 27 may be scraped by the edges of the collecting roller 24. Therefore, the width (W27) of the collecting-roller cleaning blade 27 is set narrower than the width (W24) of the collecting roller 24.

Because the collecting-roller cleaning blade 27 has the function of mechanically scraping off the toner on the surface of the collecting roller 24, the length (W27) of the collecting-roller cleaning blade 27 in the width direction is automatically set to the length (W23) or more of the cleaning brush 23 in the width direction.

In the cleaning device 20, to always efficiently move toner from the cleaning brush 23 to the collecting roller 24, the width (W39) of the cleaning-brush charge imparting unit 39 is set to the width (W23) or more of the cleaning brush 23.

If the length (W39) of the cleaning-brush charge imparting unit 39 in the width direction is shorter than the length (W23) of the cleaning brush 23 in the width direction, some brush fibers 31 in the edges of the cleaning brush 23 in the width direction cannot come in contact with the cleaning-brush charge imparting unit 39.

Toner movement from the cleaning brush 23 to the collecting roller 24 cannot satisfactorily be performed in an area where the brush fibers 31 cannot come in contact with the cleaning-brush charge imparting unit 39. Because of this, the toner is gradually deposited on the cleaning brush 23, and cleaning performance on the photosensitive element 1 is degraded, which leads to a cleaning failure. Moreover, the toner which does not move to the collecting roller 24 re-adheres to the photosensitive element 1 from the cleaning brush 23, which also leads to a cleaning failure. These cleaning failures of the photosensitive element 1 become the cause of contamination of the charging roller 3.

Meanwhile, the tip potential of the cleaning brush 23 can be prevented from decreasing at a portion where the cleaning-brush charge imparting unit 39 is in contact with the cleaning brush 23. Therefore, the length (W39) of the cleaning-brush charge imparting unit 39 in the width direction is set to be longer than the length (W23) of the cleaning brush 23 in the width direction. With this feature, all the brush fibers 31 of the cleaning brush 23 can contact the cleaning-brush charge imparting unit 39. Thus, even if the surface potential of the brush fibers 31 decreases after the toner is transferred to the collecting roller 24, the surface potential can be recovered to the predetermined potential before the brush fibers 31 contact the photosensitive element 1. As explained above, after the potential of all the brush fibers 31 provided in the cleaning brush 23 decreases due to transfer of the toner to the collecting roller 24, the potential can be recovered to the predetermined potential through contact with the cleaning-brush charge imparting unit 39. Thus, more reliable and excellent cleaning can be achieved.

Because the length (W27) of the collecting-roller cleaning blade 27 in the width direction is set to the length (W23) or more of the cleaning brush 23 in the width direction, the surface potential of the collecting roller 24 can be prevented from decreasing in a range where the cleaning brush 23 contacts the collecting roller 24, and the toner can stably move from the cleaning brush 23 to the collecting roller 24.

The printer 100 according to the first embodiment uses toner so-called spherical toner with a shape factor SF-1 of 100 to 150. When the spherical toner is used, the toner is less removed from the photosensitive element 1 using the polarity control blade 22 than that when pulverized toner is used. However, even if many toner particles pass through the cleaning brush 23, the polarity control blade 22 makes the charged polarities of the toner particles uniform to one polarity, and the cleaning brush 23 removes the toner particles from the photosensitive element 1. Thus, even if the spherical toner is used, the cleaning performance can be maintained.

Removal of toner on the collecting roller 24 will be explained below.

When the collecting-roller cleaning blade 27 is used to mechanically scrape off the toner on the collecting roller 24, the spherical toner is difficult to be removed.

How the removal of the spherical toner on the collecting roller 24 is possible will be explained below. The collecting roller 24 only has a function of transferring the toner adhering to the cleaning brush 23 to the collecting roller 24 by means of a potential gradient between the cleaning brush 23 and the collecting roller 24, and any material can be used, differently from the photosensitive element 1. To keep the potential gradient with the cleaning brush 23, a roller with a resistance of 1×10¹⁰Ω or more in the measurement method A is preferably used as the collecting roller 24.

Excellent cleaning performance of the collecting roller 24 is also required, and thus, the surface thereof may be coated with a material having a low frictional factor, or a conductive tube having a low frictional factor may be wound around a metal roller. Further, the surface of the collecting roller 24 may be insulated. Materials for insulating the surface of the collecting roller 24 include a PVDF tube, a PI tube, acrylic coat, silicone coat (e.g., coating PC containing silicone particles), and ceramics. In this case, respective values of applied voltages to the polarity control blade 22, the cleaning brush 23, and the collecting roller 24 are simply set to be appropriate allowing for use environment or the like.

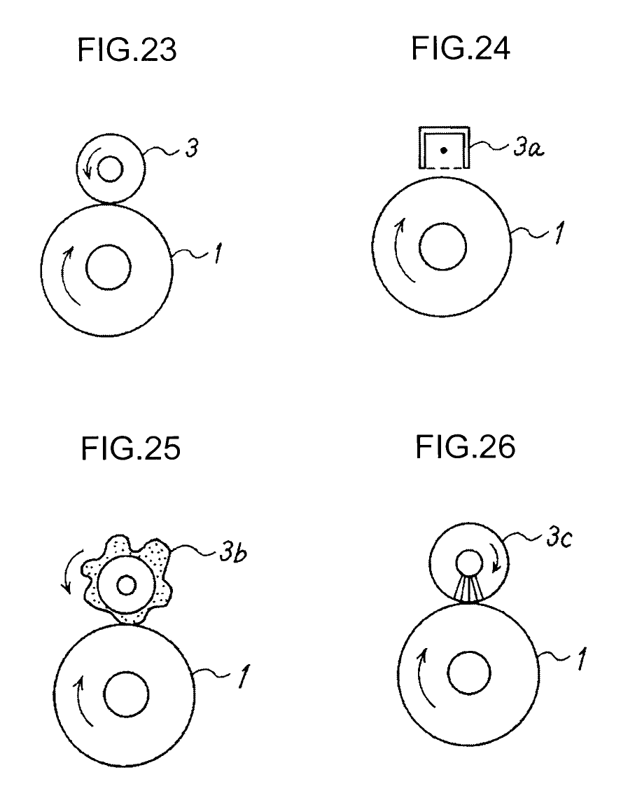

In the first embodiment, the charging roller 3 being a charging unit that charges the surface of the photosensitive element is arranged in a noncontact manner with a predetermined distance to the surface of the photosensitive element 1, however, the charging roller 3 may be in contact with the photosensitive element 1 as shown in FIG. 23. The surface of the photosensitive element may be charged not only by the charging roller 3 but also by a corona charger 3a as shown in FIG. 24. The charging unit may be a magnetic brush 3b as shown in FIG. 25, or may be a fur brush 3c as shown in FIG. 26.

The photosensitive element 1 used in the image forming apparatus according to the first embodiment will be explained in detail below.

As the photosensitive element 1 used in the first embodiment, an amorphous-silicon-base photosensitive element (hereinafter, “a-Si photosensitive element”) can be used. The a-Si photosensitive element is formed by heating a conductive base to 50° C. to 400° C. and having a photoconductive layer formed of amorphous silicon (a-Si) on the base, the photoconductive layer being obtained by using a film formation method such as a vacuum deposition method, a sputtering method, an ion plating method, a thermal chemical vacuum deposition (CVD) method, an optical CVD method, and a plasma CVD method. Among these, the plasma CVD method is used as a preferred method. This method is implemented by decomposing material gas by direct current, by high-frequency, or by microwave glow discharge and forming an a-Si deposited film on the base.

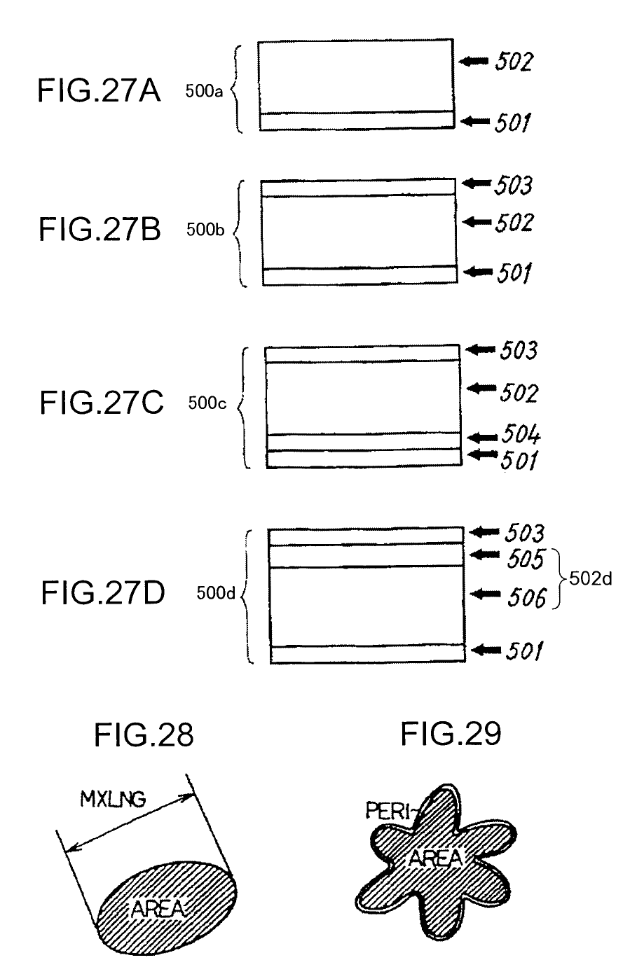

Layer structures of the a-Si photosensitive element are as follows. FIGS. 27A to 27D are schematics for explaining the layer structures. An a-Si photosensitive element 500a shown in FIG. 7A has a photoconductive layer 502 formed on a base 501, the photoconductive layer 502 being formed of a-Si: H, X and having a photoconductivity. An a-Si photosensitive element 500b shown in FIG. 7B has the photoconductive layer 502 and an a-Si surface layer 503 formed on the base 501. An a-Si photosensitive element 500c shown in FIG. 7C has the photoconductive layer 502, the a-Si surface layer 503, and an a-Si charge-application prevention layer 504 formed on the base 501. An a-Si photosensitive element 500d shown in FIG. 7D has a photoconductive layer 502d formed on the base 501. The photoconductive layer 502d is formed of a charge generation layer 505 consisting of a-Si: H, X and of a charge transport layer 506, and the a-Si surface layer 503 is provided on the photoconductive layer 502d.

The base 501 of the a-Si photosensitive element 500 (a to d) may have conductive property or electrical insulation property. Examples of a conductive base include following metals such as Al, Cr, Mo, Au, In, Nb, Te, V, Ti, Pt, Pd, and Fe, and alloys of these metals such as stainless. Any base as an electrically insulating base can also be used. More specifically, the surface of the electrically insulating base on the side where at least a photosensitive layer is formed is subjected to a conduction process, and examples of the electrically insulating base include a film or a sheet of synthetic resin such as polyester, polyethylene, polycarbonate, cellulose acetate, polypropylene, polychlorovinyl, polystyrene, and polyamide, and glass and ceramics.

The shape of the base 501 can be cylindrical, a plate, or an endless belt shape, which has a smooth surface or an irregular surface. The thickness thereof is appropriately decided so as to enable formation of a desired photosensitive element for an image forming apparatus. If flexibility is required as the photosensitive element for an image forming apparatus, the base can be made as thin as possible within a range in which a function as the base 501 can be sufficiently performed. However, the thickness of the base 501 is generally 10 micrometers or more in terms of mechanical strength or the like for manufacture and handling.

In the a-Si photosensitive element 500 which can be used in the first embodiment, it is more effective that the a-Si charge-application prevention layer 504 that has a function of preventing charge injection from the conductive base side is provided between the conductive base 501 and the photoconductive layer 502 as required (FIG. 27C). More specifically, the a-Si charge-application prevention layer 504 has a function of preventing charge injection from the base 501 side to the photoconductive layer 502 side when a free surface of the photosensitive layer is subjected to a charging process with constant polarity. When it is subjected to a charging process with opposite polarity, the function cannot be performed, or the a-Si charge-application prevention layer 504 is so-called polarity-dependent. To give the function, the a-Si charge-application prevention layer 504 is caused to contain a comparatively larger amount of atoms that control conductivity as compared with the photoconductive layer 502.

The thickness of the a-Si charge-application prevention layer 504 is preferably 0.1 micrometer to 5 micrometers, more preferably 0.3 micrometer to 4 micrometers, and most preferably 0.5 micrometer to 3 micrometers, in terms of obtaining desired electrophotographic properties and economic effects.

The photoconductive layer 502 is formed on an undercoat layer as necessary. The thickness thereof is appropriately decided as necessary in terms of obtaining desired electrophotographic properties and economic effects, and preferably 1 micrometer to 100 micrometers, more preferably 20 micrometers to 50 micrometers, and most preferably 23 micrometers to 45 micrometers.

The charge transport layer 506 is a layer mainly having a function of transporting charge when the photoconductive layer 502 is functionally separated. The charge transport layer 506 is formed of a-Si C (H, F, O) that contains, as components, at least silicone atom, carbon atom, and fluorine atom, and contains hydrogen atom and oxygen atom as required, and has desired photoconductive properties, particularly, charge holding property, charge generation property, and charge transport property. In the present invention, it is particularly preferred to contain oxygen atom.

The thickness of the charge transport layer 506 is appropriately decided as necessary in terms of obtaining desired electrophotographic properties and economic effects, and preferably 5 micrometers to 50 micrometers, more preferably 10 micrometers to 40 micrometers, and most preferably 20 micrometers to 30 micrometers.

The charge generation layer 505 is a layer mainly having a function of generating charge when the photoconductive layer 502 is functionally separated. The charge generation layer 505 is formed of a-Si: H that contains, as components, at least silicone atom, does not substantially contain carbon atom, and contains hydrogen atom as required, and has desired photoconductive properties, particularly, charge generation property and charge transport property.

The thickness of the charge generation layer 505 is appropriately decided as necessary in terms of obtaining desired electrophotographic properties and economic effects, and preferably 0.5 micrometer to 15 micrometers, more preferably 1 micrometer to 10 micrometers, and most preferably 1 micrometer to 5 micrometers.

In the a-Si photosensitive element 500 used in the first embodiment, a surface layer can further be provided on the photoconductive layer 502 formed on the base 501 as required, and it is preferred to form the a-Si surface layer 503. The a-Si surface layer 503 has a free surface, which is provided to achieve the object of the present invention mainly for humidity resistance, continuously repeated use property, electrical pressure resistance, use environment property, and durability.

It is desired that the thickness of the a-Si surface layer 503 is generally 0.01 micrometer to 3 micrometers, preferably 0.05 micrometer to 2 micrometers, and most preferably 0.1 micrometer to 1 micrometer. If the thickness is thinner than 0.01 micrometer, the a-Si surface layer 503 may be lost due to some reasons such as wear during use of the photosensitive element. If the thickness exceeds 3 micrometers, then the electrophotographic property decreases, for example, an increase in residual potential.

The a-Si photosensitive element 500 has high surface hardness and is highly sensitive to long-wavelength light such as a semiconductor laser (770 nanometers to 800 nanometers), and besides, degradation due to repeated use is hardly recognized. Therefore, the a-Si photosensitive element 500 is a photosensitive element for electrophotography suitable for use in a high-speed copier, a laser beam printer (LBP), and the like.

The photosensitive layer is provided on the conductive base, and it may contain filler in the surface layer coated on the photosensitive layer or may use an organic photosensitive element based on a charge transport material as a cross-linking type charge transport material. By containing a particle material in the surface layer of the organic photosensitive element or by using the cross-linking type charge transport material as a charge transport material, wear resistance of the surface layer can be increased.

The surface layer of the photosensitive element is formed of a polymer of compounds or a copolymer thereof selected from among vinyl fluoride, vinylidene fluoride, chlorotrifluoroethylene, tetrafluoroethylene, hexafluoropropylene, perfluoroalkylvinylether. As the filler contained in the surface layer, both an organic filler and an inorganic filler can be used, however, the inorganic filler is particularly preferably used. Examples of an organic filler material include fluororesin powder such as polytetrafluoroethylene, silicone resin powder, and a-carbon powder. Examples of an inorganic filler material include metal oxide such as silica, tin oxide, zinc oxide, titanium oxide, alumina, zirconium oxide, indium oxide, antimony oxide, bismuth oxide, calcium oxide, tin oxide doped with antimony, and indium oxide doped with tin; metallic fluoride such as tin fluoride, calcium fluoride, and aluminum fluoride; potassium titanate; and boron nitride. These fillers may be used singly or as a mixture of two or more of them. To improve dispersion, these fillers may be subjected to surface treatment using a surface treatment agent.

As the conductive base, a cylindrical cylinder or a film such as metal including aluminum and stainless steel, paper, and plastic is used. An undercoat layer (adhesion layer) having a barrier function and an undercoat function can be provided on any one of the bases. The undercoat layer is formed so as to improve adhesion properties, improve coating capability, protect the base, coat any defect on the base, improve charge injection capability from the base of the photosensitive layer, and to protect electrical coating of the photosensitive layer. Known materials of the undercoat layer include polyvinyl alcohol, poly-N-vinylimidazole, polyethylene oxide, ethyl cellulose, methyl cellulose, ethylene-acrylate copolymer, casein, polyamide, nylon copolymer, glue, and gelatine. These materials are dissolved in respectively suitable solvents and applied to the base. The film thickness is about 0.2 micrometer to about 2 micrometers.

Specific examples of the photosensitive layer include one having a laminated structure of the charge generation layer containing a charge generation material and of a charge transport layer containing a charge transport material, and one formed of a single layer containing the charge generation material and the charge transport material.

Any one of the followings can be used as the charge generation material, such as pyrylium, tiopyrylium dyes, phthalocyanine pigments, anthoanthrone pigments, dibenzpyrenequinone pigments, pyranthrone pigments, trisazo pigments, disazo pigments, azo pigments, indigo dyes, quinacridone pigments, asymmetric quinocyanine dyes, and quinocyanine dyes.

A cross-linking type charge transport material is preferably used as the charge transport material. Specifically, those as follows can be used: triarylmethane compounds such as pyrene, N-ethylcarbazole, N-isopropylcarbazole, N-methyl-N-phenylhydrazino-3-methylidene-9-ethylcarbazole, N,N-diphenylhydrazino-3-methylidene-9-ethylcarbazole, N,N-diphenylhydrazino-3-methylidene-10-ethylphenothiazin, N,N-diphenylhydrazino-3-methylidene-10-ethylphenoxazine, p-diethylaminobenzaldehyde-N,N-diphenylhydrazone, p-(diethylaminobenzaldehyde-2-methylphenyl)-phenylmethane; polyarylalkanes such as 1,1-bis(4-N,N-diethylamino-2-methylphenyl)heptane, 1,1,2,2-tetrakis(4-N,N-dimethylamino-2-methylphenyl)ethane; and triarylamine.

The photosensitive element may be provided with a protective layer on the outermost surface thereof and added with a filler to improve wear resistance. Examples of the organic filler include fluororesin powder such as polytetrafluoroethylene, silicone resin powder, and a-carbon powder. Examples of the inorganic filler include metallic powder such as cupper, tin, aluminum, and indium; metal oxide such as tin oxide, zinc oxide, titanium oxide, indium oxide, antimony oxide, bismuth oxide, tin oxide doped with antimony, and indium oxide doped with tin; and inorganic materials such as potassium titanate. These fillers may be used singly or as a mixture of two or more of them. These fillers can be dispersed by using a disperser appropriate for a protective-layer coating agent. Further, it is preferred in terms of permeability of the protective layer that an average particle size of filler is 0.5 micrometer or less, preferably 0.2 micrometer or less. A plasticizer or a leveling agent may be added in the protective layer according to the first embodiment.

Specific examples of the photosensitive element 1 are those in which a protective-layer coating agent and film thickness and forming conditions are specified as follows. More specifically, a protective layer with a thickness of 3 micrometers is formed by mixing 182 parts of methyltrimethoxysilane, 40 parts of dihydroxy methyl triphenyl amine, 225 parts of 2-propanol, 106 parts of 2% acetic acid, and 1 part of aluminum trisacetyl acetonate, to prepare an application liquid for the protective layer, applying the application liquid to the charge transport layer, drying the application liquid, and thermosetting it at 110° C. for 1 hour. Further, a surface protective layer with a thickness of 5 micrometers is formed by dissolving 30 parts of hole transport compound in the following Formula (I) and 0.6 part of acryl monomer and photopolymerization initiator (1-hydroxy-cyclohexyl-phenyl-ketone) in the following Formula (II) in a mixed solvent of 50 parts of monochlorobenzene/50 parts of dichloromethane, to prepare coating for surface protective layer, applying the coating to the charge transport layer using a spray coating method, and curing the coating using a metal halide lamp at a light intensity of 500 mW/cm² for 30 seconds.

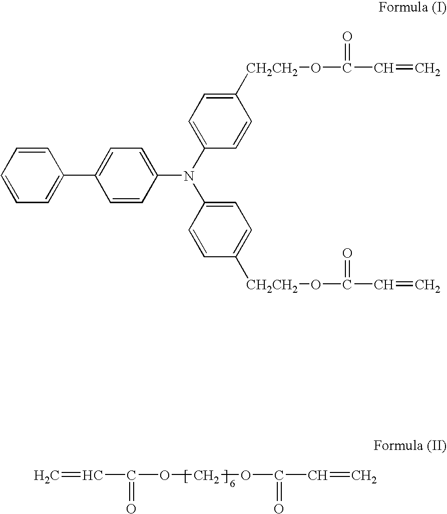

Preferred toner used in the image forming apparatus will be explained below. The first embodiment uses spherical toner with high roundness which has shape factor SF-1 of 100 to 150. If the shape of toner is close to a sphere, a contact state between toner and toner or between toner and the photosensitive element becomes point contact. Thus, attraction force between toner and toner decreases, flowability becomes high, and attraction force between toner and the photosensitive element also decreases, and a transfer rate thereby increases. If the shape factor SF-1 exceeds 150, this is not preferable because the transfer rate decreases.

FIG. 28 is a schematic representing a shape of a toner particle for explaining shape factor SF-1. The shape factor SF-1 indicates the degree of roundness of a toner shape, and is expressed by the following equation (1). The shape factor SF-1 is a value produced by dividing the square of the maximum length MXLNG of a figure, which is the projection of a spherical substance (toner in the first embodiment) in a two-dimensional plane, by the area “AREA” of the figure and then multiplying the resulting quotient by 100 π/4. That is, the shape factor SF-1 is defined by

SF-1={(MXLNG)²/AREA}×(100 π/4) (1)

FIG. 29 is a schematic representing a shape of a toner particle for explaining shape factor SF-2. The shape factor SF-2 is a value indicative of an irregularity ratio of the shape of a substance, and is expressed by a value produced by dividing the square of the peripheral length “PERI” of a figure, which is the projection of the substance in a two-dimensional plane, by the area “AREA” of the figure and then multiplying the resulting quotient by 100/4π. That is, the shape factor SF-2 is defined by

SF-2={(PERI)²/AREA}×(100/4π) (2)

The shape factor SF-2 according to the first embodiment is obtained in the following manner that 100 toner images were randomly sampled by using FE-SEM (S-800) manufactured by HITACHI, LTD., and the resulting image information was introduced in an image analyzer (LUSEX3) manufactured by NIRECO CORP. via an interface, and was analyzed and calculated using the equation (2).

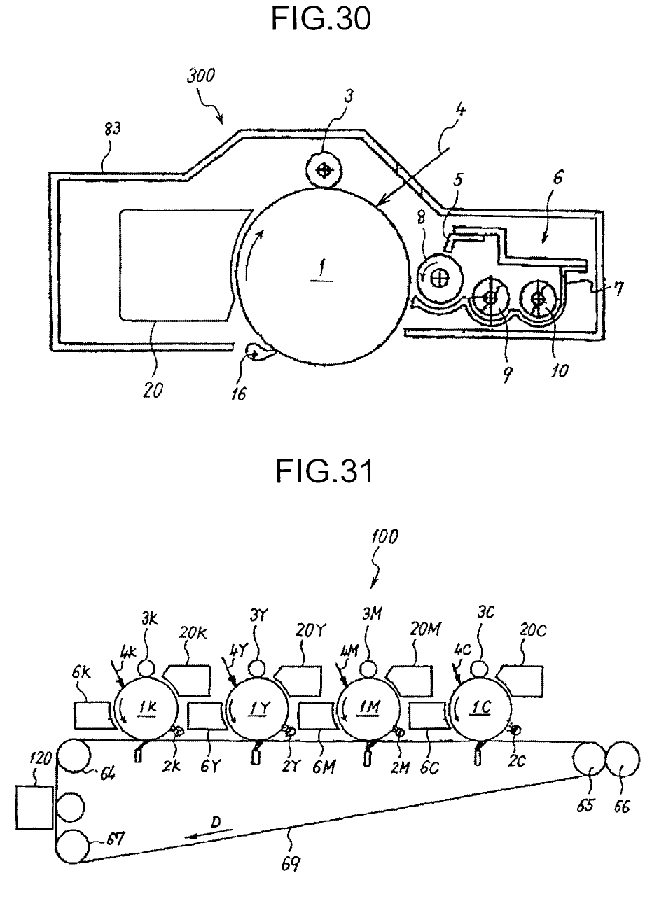

As shown in FIG. 30, the image forming apparatus may be a process cartridge 300 being an image carrier unit that integrally supports the photosensitive element 1 being the image carrier and the cleaning device 20 in a housing 83 and is detachable with respect to the body of the printer 100. In FIG. 30, the process cartridge also includes the charging roller 3 and the developing device 6 which are also integrally supported by the housing in addition to the photosensitive element 1 and the cleaning device 20. However, the process cartridge only has to integrally support at least the photosensitive element 1 and the cleaning device 20.

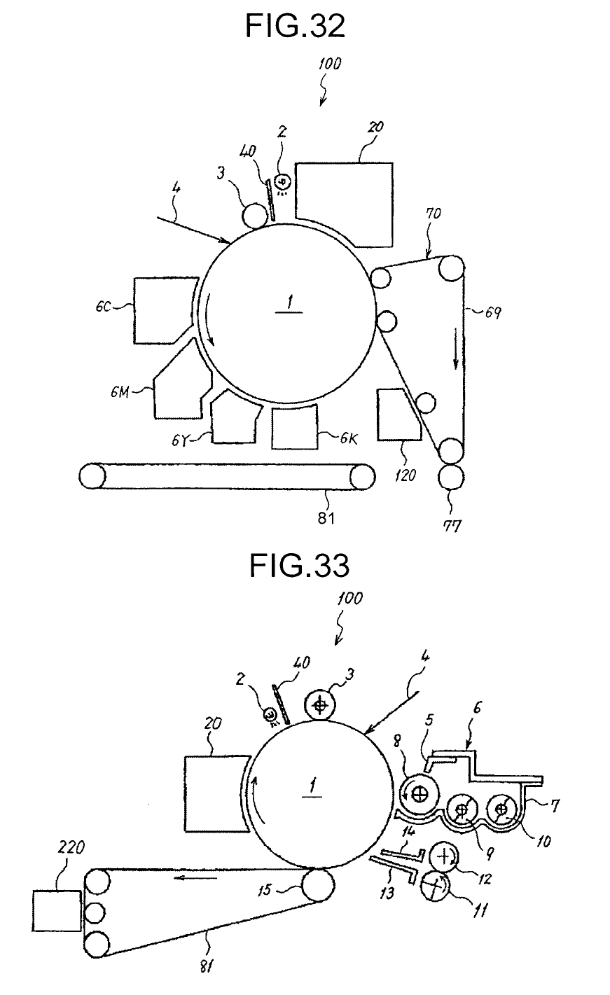

An example of applying the cleaning device 20 according to the present invention to a color image forming apparatus will be explained below with reference to FIGS. 31 and 32.

FIG. 31 is a schematic of an example of applying the cleaning device 20 according to the present invention to the printer 100 which is a tandem-type full-color image forming apparatus. The printer 100 includes an intermediate transfer belt 69 stretched and supported by a plurality of rollers 65, 64, and 67 so as to be long in the horizontal direction when it is set on a horizontal plane. The surface of the intermediate transfer belt 69 moves in the direction indicated by arrow D in FIG. 31. Arranged along the flat portion of the intermediate transfer belt 69 extending in the horizontal direction are four photosensitive elements 1Y, 1M, 1C, and 1K. Arranged around each photosensitive element 1 (Y, M, C, K) are the charging roller 3 (Y, M, C, K) as a charging unit, the developing device 6 (Y, M, C, K) as a developing unit, the neutralizing lamp 2 (Y, M, C, K), and the cleaning device 20 (Y, M, C, K), and the like. The printer 100 also includes a paper feed cassette (not shown) that stores sheets of recording paper as a plurality of recording materials. The sheets of recording paper in the paper feed cassette are fed by a paper feed roller (not shown) sheet by sheet, and a timing of each sheet is adjusted by a registration roller pair (not shown), and then the sheet is fed to a secondary transfer area between a secondary transfer roller 66 and the intermediate transfer belt 69.

When an image is formed using the printer 100 of FIG. 31, first, each photosensitive element 1 is made to rotate in the counterclockwise in FIG. 31 and the intermediate transfer belt 69 is made to rotate in the clockwise in FIG. 31. Then, the surface of the photosensitive element 1 is uniformly charged by the charging roller 3 and is irradiated with the laser beam 4 (Y, M, C, K) modulated based on each image data, and an electrostatic latent image for each color is formed on the surface of the photosensitive element 1. Toner of each color adheres to the electrostatic latent image of each color on the surface thereof by the developing device 6, and a toner image of each color is thereby formed. The toner images of the colors are primarily transferred to the intermediate transfer belt 69 so as to be mutually superimposed on one another. The toner images of the colors on the intermediate transfer belt 69 in a state of their mutual superimposition on one another are transferred to the recording paper conveyed to the secondary transfer area by the secondary transfer roller 66.

The recording paper to which the toner images are transferred in the above manner is conveyed to a fixing unit (not shown), where the recording paper is heated and pressed to fix the toner images on the recording paper. The recording paper with the fixed toner images are discharged onto a paper discharge tray (not shown). The residual toner remaining on the surface of the photosensitive element 1 after the transfer of the toner images is removed by the cleaning device 20. Meanwhile, the residual toner remaining on the surface of the intermediate transfer belt 69 is removed by an intermediate-transfer-belt cleaning device 120. The same configuration as the cleaning device 20 according to the present invention can also be applied to the intermediate-transfer-belt cleaning device 120.

The tandem-type full-color image forming apparatus shown in FIG. 31 can satisfactorily remove the residual toner from the surface of the photosensitive element 1 even if the toner is spherical toner using the cleaning device 20 being a cleaning unit that cleans the residual toner remaining on the surface of the photosensitive element 1. Further, even if the polarity of most of the residual toner is changed to the positive polarity or to the negative polarity due to a change of the environment, the residual toner can excellently be removed from the photosensitive element 1. The residual toner can be satisfactorily removed from the surface of the intermediate transfer belt 69 even if the toner is spherical toner using the intermediate-transfer-belt cleaning device 120 being a cleaning unit for the intermediate transfer belt that cleans the residual toner remaining on the surface of the intermediate transfer belt 69 without being transferred to the transfer paper. Further, even if the polarity of most of the residual toner on the intermediate transfer belt 69 is changed to the positive polarity or to the negative polarity due to a change of the environment, the residual toner can excellently be removed from the intermediate transfer belt 69.

FIG. 32 is a schematic of an example of applying the cleaning device 20 according to the present invention to the printer 100 which is a one-drum type full-color image forming apparatus. The printer 100 includes the photosensitive element 1 in a housing of the body (not shown). Arranged around the photosensitive element 1 are the charging roller 3 as a charging unit, developing devices 6C, 6M, 6Y, and 6K corresponding to the colors of cyan (C), magenta (M), yellow (Y), and black (K) respectively, an intermediate transfer unit 70, and the cleaning device 20 as a cleaning unit. Furthermore, the printer 100 includes a paper feed cassette (not shown) that stores sheets of recording paper as a plurality of recording materials. The sheets of recording paper in the paper feed cassette are fed by a paper feed roller (not shown) sheet by sheet, and a timing of each sheet is adjusted by a registration roller pair (not shown), and then the sheet is fed to a secondary transfer area between a secondary transfer unit 77 and the intermediate transfer unit 70.

When an image is formed using the printer 100 of FIG. 32, first, the photosensitive element 1 is made to rotate in the counterclockwise in FIG. 32 and the intermediate transfer belt 69 of the intermediate transfer unit 70 is made to rotate in the clockwise in FIG. 32. Then, the surface of the photosensitive element 1 is uniformly charged by the charging roller 3 and is irradiated with the laser beam 4 modulated based on image data for C, and a C-electrostatic latent image is formed on the surface of the photosensitive element 1. The C-electrostatic latent image is developed using toner C by the developing device 6C. A C-toner image obtained in the above manner is primarily transferred to the intermediate transfer belt 69 of the intermediate transfer unit 70. Thereafter, the residual toner remaining on the surface of the photosensitive element 1 is removed by the cleaning device 20, and then, the surface of the photosensitive element 1 is again uniformly charged by the charging roller 3.

Next, the surface of the photosensitive element 1 is irradiated with the laser beam 4 modulated based on image data for M, and an M-electrostatic latent image is formed on the surface of the photosensitive element 1. The M-electrostatic latent image is developed using toner M by the developing device 6M. An M-toner image obtained in the above manner is primarily transferred to the intermediate transfer belt 69 so as to be superimposed on the C-toner image already primarily transferred to the intermediate transfer belt 69. Hereinafter, a Y toner image and a K toner image are obtained similarly to the above and are primarily transferred to the intermediate transfer belt 69. The toner images on the intermediate transfer belt 69 in a state of their mutually superimposed on one another obtained in the above manner are transferred by the secondary transfer unit 77 to the recording paper conveyed to the secondary transfer area.

The recording paper to which the toner images are transferred in the above manner is conveyed to a fixing unit (not shown) by a paper conveyor belt 81. The recording paper is heated and pressed by the fixing unit to fix the toner images on the recording paper. The recording paper with the fixed toner images are discharged onto a paper discharge tray (not shown). The residual toner remaining on the surface of the photosensitive element 1 after the toner images are transferred is removed by the cleaning device 20. Meanwhile, the residual toner remaining on the surface of the intermediate transfer belt 69 is removed by the intermediate-transfer-belt cleaning device 120. The same configuration as the cleaning device 20 according to the present invention can also be applied to the intermediate-transfer-belt cleaning device 120.

The one-drum type full-color image forming apparatus shown in FIG. 32 can excellently remove the residual toner from the surface of the photosensitive element 1 even if the toner is spherical toner using the cleaning device 20 being a cleaning unit that cleans the residual toner remaining on the surface of the photosensitive element 1. Further, even if the polarity of most of the residual toner is changed to the positive polarity or to the negative polarity due to a change of the environment, the residual toner can excellently be removed from the photosensitive element 1. Meanwhile, the residual toner can be satisfactorily removed from the surface of the intermediate transfer belt 69 even if the toner is the spherical toner using the intermediate-transfer-belt cleaning device 120 being a cleaning unit for the intermediate transfer belt that cleans the residual toner remaining on the surface of the intermediate transfer belt 69 without being transferred to the transfer paper. Further, even if the polarity of most of the residual toner on the intermediate transfer belt 69 is changed to the positive polarity or to the negative polarity due to a change of the environment, the residual toner can excellently be removed from the intermediate transfer belt 69.

As shown in FIG. 33, a cleaning device having the same configuration as that of the cleaning device 20 may be used as a conveyor-belt cleaning unit that removes toner adhering to the paper conveyor belt 81. If paper jam occurs in the printer 100 shown in FIG. 33, the toner image on the photosensitive element 1 is transferred to the paper conveyor belt 81, which causes the paper conveyor belt 81 to be contaminated. Further, there is a case where toner with a low amount of charge or positively charged toner in the developing roller 8 may adhere to a space between papers on the photosensitive element 1. The toner adhering to the space between the papers is transferred to the paper conveyor belt 81 to cause the paper conveyor belt 81 to be contaminated. Part of the toner adhering to the paper conveyor belt 81 due to the paper jam or the like is injected with charge by the transfer roller 15 and the polarity of the toner is reversed. As a result, the toner as dirt transferred to the paper conveyor belt 81 is a mixture of toner with the positive polarity and toner with the negative polarity. However, by using a conveyor-belt cleaning device 220, being a paper-conveyor-belt cleaning unit, having the same configuration as the cleaning device 20 according to the present invention, the toner in which the positive polarity and the negative polarity are mixed on the paper conveyor belt 81 can be excellently removed.

According to the first embodiment, the cleaning device 20 includes the cleaning brush 23 that is the brush roller in which the conductive brush fibers 31 are arranged so as to extend outward in the radial direction from the outer periphery of the conductive core bar 23a and causes the brush fibers 31, while rotating around the core bar 23a, to come in contact with the surface of the photosensitive element 1 being an element to be cleaned whose surface moves. The cleaning device 20 also includes the brush power supply 30 being the brush-roller voltage applying unit that applies a voltage to the core bar 23a, and the collecting roller 24 being the brush-roller cleaning unit that contacts the brush fibers 31 at a location different from the location where the brush fibers 31 and the photosensitive element 1 contact each other. The cleaning device 20 removes the toner from the photosensitive element 1 by causing the toner on the photosensitive element 1 to adhere to the brush fibers 31 applied with the voltage, and removes the toner adhering to the brush fibers 31 of the cleaning brush 23 by the collecting roller 24.

In the cleaning device 20 configured in the above manner, the brush fiber 31 has the core sheath structure in which the inner side thereof is formed of the conductive material 32 and the surface portion thereof is formed of the insulating material 33, it is thereby possible to minimize charge injection to the toner that is removed from the cleaning brush 23. Consequently, it is possible to prevent a cleaning failure caused by the toner of which charge polarity is reversed due to charge injection thereto from the cleaning brush 23 resulting in re-adhesion of the toner to the photosensitive element or in being incapable of removing the toner from the photosensitive element 1.

The cleaning device 20 further includes the cleaning-brush charge imparting unit 39 being a brush-fiber charge imparting unit that comes in contact with the brush fibers 31 in the downstream side of the location where the brush fibers 31 and the collecting roller 24 contact each other in the rotational direction of the cleaning brush 23, and in the upstream side of the location where the brush fibers 31 and the photosensitive element 1 contact each other in the rotational direction of the cleaning brush 23, and the cleaning-brush charge imparting unit 39 being applied with the voltage with the same polarity as the voltage applied to the brush fibers 31. The cleaning device 20 also includes the brush-charge imparting power supply 34 being the brush-charge-imparting-unit voltage applying unit that applies a voltage to the cleaning-brush charge imparting unit 39.

In the configuration, even if the tip potential of the brush fibers 31 decreases due to transfer of the toner from the cleaning brush 23 to the collecting roller 24, the tip potential of the brush fibers 31 can be recovered to the potential of the cleaning-brush charge imparting unit 39 by the cleaning-brush charge imparting unit 39. Thus, it is possible to prevent a cleaning failure caused by decrease in the tip potential of the brush fibers 31 and therefore achieve more reliable and excellent cleaning.

The length (W39) of the cleaning-brush charge imparting unit 39 is set to the length (W23) or more of the cleaning brush 23 in the direction of the rotating shaft of the cleaning brush 23, and therefore all the brush fibers 31 provided in the cleaning brush 23 can contact the cleaning-brush charge imparting unit 39. Consequently, even if the surface potential of the brush fibers 31 decrease after the toner is transferred to the collecting roller 24, the surface potential can be recovered to the predetermined potential before the brush fibers 31 contact the photosensitive element 1. As explained above, after the potentials of all the brush fibers 31 decrease due to transfer of the toner to the collecting roller 24, the potentials can be recovered to the predetermined potential by coming in contact with the cleaning-brush charge imparting unit 39, and thus more reliable and satisfactory cleaning can be achieved.

Further, because the brush fibers 31 of the cleaning brush 23 are inclined backward in the rotational direction of the cleaning brush 23, even if the conductive material 32 inside each brush fiber 31 is exposed at the tip portion of the brush fiber 31, the toner can be prevented from contacting the conductive material 32. Thus, it is possible to minimize charge injection to the toner to be removed from the cleaning brush 23 and prevent occurrence of a cleaning failure caused by the charge injection to the toner.

The brush-roller cleaning unit is the collecting roller 24 that is applied with a voltage by the collection power supply 28 being a collecting-roller voltage applying unit, and that electrostatically attracts the toner adhering to the brush fibers 31, to collect the toner. Because of this, the collecting roller 24 electrostatically attracts the toner adhering to the cleaning brush 23 to thereby enable removal of the toner from the cleaning brush 23, and the brush fibers 31 without toner can be brought into contact with the photosensitive element 1, which enables excellent cleaning performance to be maintained. Furthermore, a roller surface layer including an electrically resistive layer or insulating layer is provided around the peripheral surface of the collecting roller 24. Thus, the polarity of the toner held between the brush fibers 31 and the collecting roller 24 is difficult to be reversed, and it is thereby possible to prevent re-adhesion of the toner with the reversed polarity from the cleaning brush 23 to the photosensitive element 1.

The surface resistivity of the surface layer of the collecting roller 24 is 1×10¹⁰ Ω/cm² or more, and it is thereby possible to more reliably prevent reversal of the polarity of the toner held between the brush fibers 31 and the collecting roller 24.

The cleaning device 20 further includes the collecting-roller cleaning blade 27 being a roller-surface charge imparting unit applied with a voltage with the same polarity as the voltage applied to the collecting roller 24, and the roller-cleaning-blade power supply 42 being a roller-charge-imparting-unit voltage applying unit that applies a voltage to the collecting-roller cleaning blade 27. With this configuration, the surface potential of the collecting roller 24 is stabilized, and a potential difference between the tip potential of the brush fibers 31 and the surface potential of the collecting roller 24 is stabilized, to enable stable toner collection from the cleaning brush 23 to the collecting roller 24.

The collecting-roller cleaning blade 27 is provided as the collecting-roller cleaning unit that is formed of a conductive material and comes in contact with the surface of the collecting roller 24 to scrape off the toner from the surface of the collecting roller 24. Because the roller-surface charge imparting unit is the collecting-roller cleaning blade 27, the collecting-roller cleaning blade 27 gives charge to the surface of the collecting roller 24 while scraping off the toner from the collecting roller 24, and thus the decrease in the surface potential of the collecting roller 24 can be prevented. Consequently, it is possible to prevent decrease in collection performance of the toner from the cleaning brush 23 to the collecting roller 24, and excellent cleaning performance can thereby be maintained.

The cleaning device 20 further includes the polarity control blade 22 being a toner-polarity control unit that contacts the surface of the photosensitive element 1 in the upstream side of the location where the brush fibers 31 of the cleaning brush 23 remove the toner on the photosensitive element 1 in the movement direction of the surface of the photosensitive element 1, is applied with a voltage with the opposite polarity (negative polarity) to that of the cleaning brush 23, and controls the polarity of the toner on the photosensitive element 1. With this configuration, most of the residual toner can be removed from the surface of the photosensitive element 1 through mechanical rubbing by the blade. Moreover, a voltage with the opposite polarity to that of the cleaning brush 23 is applied to the polarity control blade 22, and thus the charge polarities of the toner particles passing through the contact portion between the polarity control blade 22 and the photosensitive element 1 can be made uniform to the opposite polarity. With this feature, the toner on the photosensitive element 1 can be reliably removed by the cleaning brush 23. Further, the polarities of the toner particles input to the contact portion between the cleaning brush 23 and the photosensitive element 1 are made uniform to one side. Thus, the cleaning brush 23 has a simple configuration such that only one brush is required because by applying the opposite polarity to that of toner to the brush, the toner can be cleaned, and the brush thereby electrostatically removes the residual toner in which toner with the positive polarity and toner with the negative polarity are mixed.

The toner-polarity control unit is the polarity control blade 22 formed of a conductive blade, it is thereby possible, with a simple configuration, to realize a unit that removes toner through rubbing and makes uniform the charge polarities of the toner particles which cannot be removed to one side. Further, the toner is removed in the contact portion with the polarity control blade 22, and thus the amount of toner input to the contact portion between the cleaning brush 23 and the photosensitive element 1 can be reduced.

Moreover, higher image quality can be achieved by using spherical toner, and excellent cleaning can be performed by cleaning the spherical toner using the cleaning device 20 even if the spherical toner is more difficult to be cleaned than pulverized toner in the mechanical cleaning.

The high-roundness spherical toner which has shape factor SF-1 of 100 to 150 is used. If the shape of toner is close to a sphere, a contact state between toner and toner or between toner and the photosensitive element 1 becomes point contact. Thus, attraction force between toner and toner decreases, flowability becomes high, and attraction force between toner and the photosensitive element also decreases, and a transfer rate can thereby be increased, which allows high-quality image.

The cleaning device 20 according to the first embodiment is used as a latent-image-carrier cleaning unit that cleans the photosensitive element 1 provided in the printer 100, and this allows excellent cleaning of the residual toner on the photosensitive element 1. Thus, high-quality image formation can be achieved.

The cleaning device 20 according to the first embodiment is used as the latent-image-carrier cleaning unit when the printer 100 is the one-drum type full-color image forming apparatus, and this allows excellent cleaning of the residual toner on the photosensitive element 1. By enabling excellent cleaning of the residual toner on the photosensitive element 1, the residual toner thereon can be prevented from being input to the developing device 6 for any other color, which allows prevention of occurrence of color mixture. Thus, high-quality image formation can be achieved.

The cleaning device 20 according to the first embodiment is used as the latent-image-carrier cleaning unit when the printer 100 is the tandem-type full-color image forming apparatus, and this allows excellent cleaning of the residual toner on each photosensitive element 1. Thus, high-quality image formation can be achieved.

The intermediate-transfer-belt cleaning device 120 having the same configuration as that of the cleaning device 20 is used as an intermediate-transfer-element cleaning unit that cleans the intermediate transfer belt 69 being an intermediate transfer element, and this allows excellent cleaning of the residual toner on the intermediate transfer belt 69. By enabling excellent cleaning of the residual toner thereon, the residual toner can be prevented from adhering to the photosensitive element 1 for any other color, which allows prevention of occurrence of color mixture. Thus, high-quality image formation can be achieved.

The conveyor-belt cleaning device 220 having the same configuration as the cleaning device 20 according to the first embodiment is used as a recording-medium-conveying-unit cleaning unit that cleans the paper conveyor belt 81 being a recording-medium conveying unit that conveys a transfer paper, and this allows excellent cleaning of the toner adhering to the paper conveyor belt 81. By enabling excellent cleaning of the toner adhering thereto, it is possible to prevent any smudge on the back of a transfer paper.

Any element formed of a material in which a filler is dispersed in the surface layer or the photosensitive layer is used as the photosensitive element 1. In this case also, the film scraped amount of the photosensitive element 1 can be reduced, and thus wear resistance can be improved. Consequently, it is possible to prevent irregularities due to scrape-off of the surface of the photosensitive element. As a result, a contact pressure between the photosensitive element and the cleaning blade can be kept uniform in the axial direction, and thus, it is possible to minimize occurrence of a portion with a low contact pressure between the photosensitive element and the cleaning blade where a scrape-through of toner easily occurs, and to prevent the scrape-through of toner.

The photosensitive element 1 is an organic photosensitive element having a surface layer reinforced with a filling agent, an organic photosensitive element that uses a cross-linking type charge transport material, or an organic photosensitive element having the both characteristics, and thus, the film scraped amount of the photosensitive element can be reduced.

By using an element whose photosensitive layer is formed of amorphous silicon as the photosensitive element 1, the film scraped amount of the photosensitive element can be reduced, and wear can be minimized. With this feature, it is possible to prevent irregularities due to scrape-off of the surface of the photosensitive element through wearing. As a result, a contact pressure between the photosensitive element and the cleaning blade can be kept uniform in the axial direction, and thus, it is possible to minimize occurrence of a portion with a low contact pressure between the photosensitive element and the cleaning blade where a scrape-through of toner easily occurs, and to prevent the scrape-through of toner.

The image forming apparatus may be the process cartridge 300 that integrally includes the photosensitive element 1 and at least the cleaning device 20, and this allows the cleaning device 20 and the photosensitive element 1 to be easily detachable with respect to the printer 100. Thus, operability upon replacement of the components can be improved.

As explained above, the cleaning device according to the first embodiment includes the brush-fiber charge imparting unit that comes in contact with the brush fibers in the downstream side of the location where the brush fibers and the collecting roller contact each other in the rotational direction of the brush roller, and to which a voltage with the same polarity as that applied to the brush fibers is applied. The location where the brush-fiber charge imparting unit contacts the brush fibers is in the downstream side than the location where the brush fibers of the cleaning brush contact the collecting roller and in the upstream side than the location where the brush fibers contact the surface of the photosensitive element in the rotational direction of the cleaning brush.

In the cleaning device according to the first embodiment, even if the tip potential of the brush fibers decreases due to transfer of the toner from the cleaning brush to the collecting roller, the tip potential of the brush fibers can be recovered by the brush-fiber charge imparting unit. Thus, it is possible to prevent a cleaning failure caused by decrease in the tip potential of the brush fibers.

However, in the cleaning device including the brush-fiber charge imparting unit as explained in the first embodiment, if the brush-fiber charge imparting unit is arranged so that the location thereof with respect to the brush roller is fixed, the following problem may arise.

The brush roller contacts the surface of the photosensitive element so as to be pressed into the surface thereof, and thus the fibers of the brush roller become bent over time and a turning radius of the tips of the brush fibers thereby decreases over time. Because of this, the brush-fiber charge imparting unit needs to be arranged so as to be pressed into the brush roller at least at the start of using it. When the brush-fiber charge imparting unit is fixedly arranged so as to be pressed into the brush roller, the brush-fiber charge imparting unit functions as a flicker element with respect to the brush roller.

More specifically, at a location where the brush fibers contact the brush-fiber charge imparting unit, even if a base portion of the brush fibers moves in the downstream side in the rotational direction through a rotation of the brush roller, the tips of the brush fibers are caught on the brush-fiber charge imparting unit. This state causes the brush fibers to be bent as compared with the location where nothing contacts the brush fibers. A further rotation of the brush roller causes the tips of the brush fibers to be released from the brush-fiber charge imparting unit, and when the state is recovered from the bent state due to elasticity of the brush fibers, the tips of the brush fibers move swiftly. At this time, if some toner which is not collected by the collecting roller adheres to the brush fibers, the toner is flicked from the brush fibers due to a momentum generated by the tips of the brush fibers being released from the brush-fiber charge imparting unit and recovery of the bending of the brush fibers. If the toner flicked from the brush fibers adheres to the surface of the photosensitive element after passing through the contact portion between the brush roller and the photosensitive element, the adhesion causes a cleaning failure of the photosensitive element.

The problem may possibly arise not only in the cleaning device that cleans the photosensitive element but also in any cleaning device that removes the toner from the element to be cleaned.

A cleaning device according to a second embodiment has been achieved to solve the problem. An object of the cleaning device according to the second embodiment is as follows. Even if the turning radius of the tips of the brush decreases over time, the contact between the brush fibers and the brush-fiber charge imparting unit is maintained, and thus more reliable and satisfactory cleaning can be achieved even after time passes, as compared with the case in which the brush-fiber charge imparting unit is fixedly arranged. Moreover, the bending of the brush fibers that contact the brush-fiber charge imparting unit can be reduced, and this prevents the tips of the brush fibers from moving swiftly when the brush fibers are recovered from the bent state. Therefore, it is possible to prevent the toner adhering to the brush fibers of the brush roller from being flicked from the brush fibers at the contact position between the brush-fiber charge imparting unit and the brush fibers and from re-adhering to the photosensitive element. Thus, more reliable and satisfactory cleaning can be achieved.

The second embodiment applied to an electrophotographic copying machine (hereinafter, “printer 1100”) that is the image forming apparatus according to the present invention will be explained below.

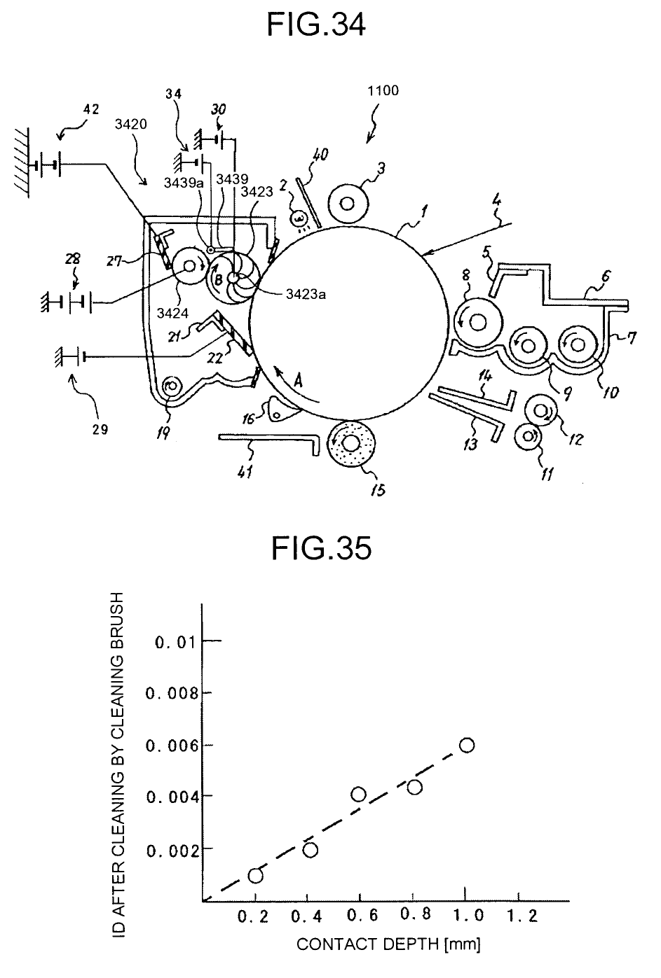

FIG. 34 is a schematic of the main portion of the printer 1100 according to the second embodiment. The printer 1100 performs single-color copying, and performs monochrome image formation based on image data read by an image reader (not shown).

The main configuration of the printer 1100 of FIG. 34 except a brush charge imparting unit 3439 and a charge-imparting-unit rotating shaft 3439a is the same as the first embodiment. The configurations of the brush charge imparting unit 3439 and the charge-imparting-unit rotating shaft 3439a as characteristics of the second embodiment will be explained below with reference to the first embodiment.

As shown in FIG. 1, the first embodiment can prevent the cleaning failure caused by decrease in the tip potential of the brush fibers 31 even if the cleaning-brush charge imparting unit 39 is fixedly arranged to the cleaning brush 23. However, such trouble that toner adhering to the cleaning brush 23 scatters sometimes occurs when the cleaning-brush charge imparting unit 39 is fixedly arranged to the cleaning brush 23.

The trouble that may occur when the cleaning-brush charge imparting unit 39 is fixedly arranged to the cleaning brush 23 will be explained below.

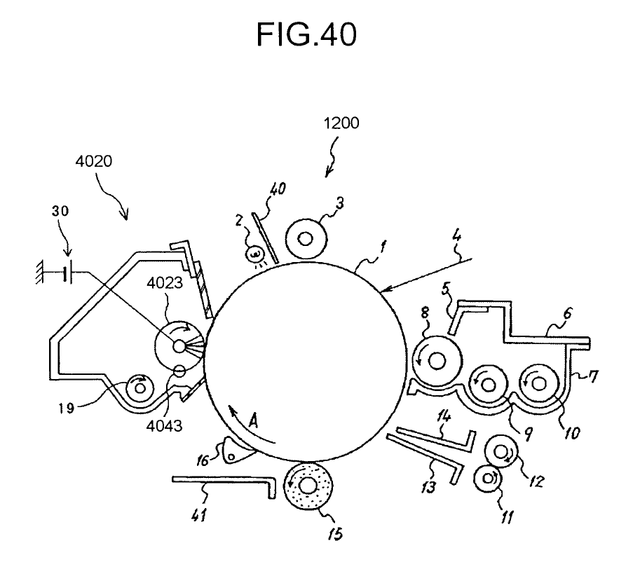

FIG. 40 is a schematic of a printer 1200 according to a comparative example that includes a cleaning device 4020 of a flicker bar system that mechanically flicks toner adhering to a cleaning brush 4023. The configuration of FIG. 40 is different from the cleaning device 20 of FIG. 1 and a cleaning device 3420 of FIG. 34 that electrostatically remove toner adhering to the cleaning brushes 23 and 3423 by the collecting rollers 24 and 3424, respectively.

The cleaning device 4020 of the flicker bar system is configured in most cases to press a plate element or a bar element into the cleaning brush 4023 and fixedly arranged thereto. In the cleaning device 4020 shown in FIG. 40, toner on a flicker bar 4043 drops in the downstream side of rotational direction (left side of the flicker bar 4043 in FIG. 40). The reason is as follows.

More specifically, because the flicker bar 4043 is pressed into the cleaning brush 4023, when the cleaning brush 4023 with the toner thereon comes in contact with the flicker bar 4043, the brush fibers are fallen and the diameter of the cleaning brush 4023 is thereby decreased. The brush fibers of the cleaning brush 4023 having passed through the flicker bar 4043 rise so as to recover to an original diameter. The toner is flicked from the brush fibers by inertia force at this time.

Meanwhile, in the cleaning device 3420 according to the second embodiment, the brush charge imparting unit 3439 formed of metal fixedly arranged to a cleaning brush 3423 functions similarly to the flicker bar 4043 shown in FIG. 40, and flicks the toner adhering to the brush fibers 31, and this may cause toner scattering to occur.

More specifically, as shown in the cleaning device 3420 according to the second embodiment, by pressing the metal-made brush charge imparting unit 3439 into the cleaning brush 3423 to be fixedly arranged to the cleaning brush 3423, similarly to the flicker bar 4043, toner adheres to the surface of the photosensitive element 1 in the downstream side of the brush charge imparting unit 3439 or in the downstream side in the surface movement direction from the location where the surface of the photosensitive element 1 contacts the cleaning brush 3423, resultantly, the toner becomes similar to the toner which is not cleaned.

FIG. 35 is a graph representing a relationship between contact depth and cleaning performance when the contact depth of the bar-type cleaning-brush charge imparting unit 39 to the cleaning brush 23 is changed when the bar-type cleaning-brush charge imparting unit 39 is fixedly arranged to the cleaning brush 23, as shown in the cleaning device 20 according to the first embodiment of FIG. 1.

“ID after cleaning by cleaning brush” plotted on the vertical axis of FIG. 35 represents residual ID after cleaning. The residual ID after cleaning represents a following index. The “residual ID after cleaning” is a value obtained by subtracting a second image density (ID) from a first ID. More specifically, the first ID is a total value of toner, a piece of tape, and a white paper, obtained by transferring the toner on the photosensitive element 1 after being cleaned by the cleaning brush 23 to the piece of tape using Scotch tape, taping the piece of tape with the toner thereon on the white paper, and measuring it using Spectrodensitometer (X-Rite manufactured by AM TEC Co.), while by taping only a piece of tape on the same white paper using Scotch tape and measuring it by the Spectrodensitometer. The second ID is a total value of a piece of tape and a white paper on which the piece of tape is taped using Scotch tape. The ID and the number of toner particles have a correlation, and the value of ID increases as the number of toner particles increases. Therefore, it is possible to determine based on the ID whether the cleaning performance is appropriate. In other words, the index indicates that cleaning performance is better with a smaller value of the residual ID after cleaning.

As shown in FIG. 35, when the contact depth of the cleaning-brush charge imparting unit 39 is decreased, the amount of toner scattering naturally decreases. Therefore, the contact depth is set to, for example, 0.2 millimeter or less. However, the cleaning brush 23 is pressed into both the photosensitive element 1 and the collecting roller 24 by 1 millimeter each, and the diameter is thereby getting smaller with time.

For example, if the brush fibers 31 used in the printer 100 are used, then the diameter thereof decreases by about 0.5 millimeter through image formation of 100000 sheets. Therefore, when the cleaning-brush charge imparting unit 39 is fixedly arranged, the cleaning-brush charge imparting unit 39 will hardly contact the cleaning brush 23 after the image formation of 100000 sheets even if it is pressed into the cleaning brush 23 by 0.25 millimeter, and the effect is eliminated. Thereafter, the diameter further decreases with time, and eventually, the diameter of the brush fibers 31 decreases to the contact depth to the photosensitive element 1 or to the collecting roller 24. More specifically, because the contact depth is 1 millimeter, a distance (radius) up to the tips of the brush fibers 31 decreases by 1 millimeter and an outer diameter of the cleaning brush 23 decreases by 2 millimeters.

To solve any failure that may possibly occur in the cleaning device 20 according to the first embodiment, the cleaning device 3420 provided in the printer 1100 according to the second embodiment has a configuration as follows.

One end of a plate element being the brush charge imparting unit 3439 is fixed to the charge-imparting-unit rotating shaft 3439a, and the plate-like brush charge imparting unit 3439 is rotatably arranged around the charge-imparting-unit rotating shaft 3439a. The brush charge imparting unit 3439 rotates around the charge-imparting-unit rotating shaft 3439a, so that a distance with a core bar 3423a is variable. The brush charge imparting unit 3439 as a biasing unit rotates around the charge-imparting-unit rotating shaft 3439a under its own weight, and is thereby biased toward the cleaning brush 3423, to come in contact with the cleaning brush 3423.

As shown in FIG. 34, when force is applied to the brush fibers so as to be bent by biasing the brush charge imparting unit 3439 toward the brush fibers 31 of the cleaning brush 3423 under its own weight to be pressed and contacted with the brush fibers 31, the brush charge imparting unit 3439 moves in the direction of being separated from the brush fibers 31 due to the firmness of the brush fibers 31, so that the bending of the brush fibers 31 can be reduced.

Thus, a flicker effect of the cleaning brush 3423 can be reduced, and this allows prevention of toner scattering and prevention of re-adhesion of toner to the photosensitive element 1. Further, because the brush charge imparting unit 3439 presses and contacts the cleaning brush 3423 under its own weight, the brush charge imparting unit 3439 can contact the cleaning brush 3423 even if the diameter of the cleaning brush 3423 decreases over time, and the cleaning failure caused by decrease in the tip potential of the brush fibers 31 can be prevented.

It is noted that a plate element made of metal (SUS) with a thickness of 2 millimeters is used as the brush charge imparting unit 3439 in the second embodiment.

In the cleaning device 3420 as shown in FIG. 34, the configuration in which the cleaning brush 3423 is pressed by and contacted with the brush charge imparting unit 3439 under its own weight is explained. However, the configuration is not limited to the configuration as explained above.

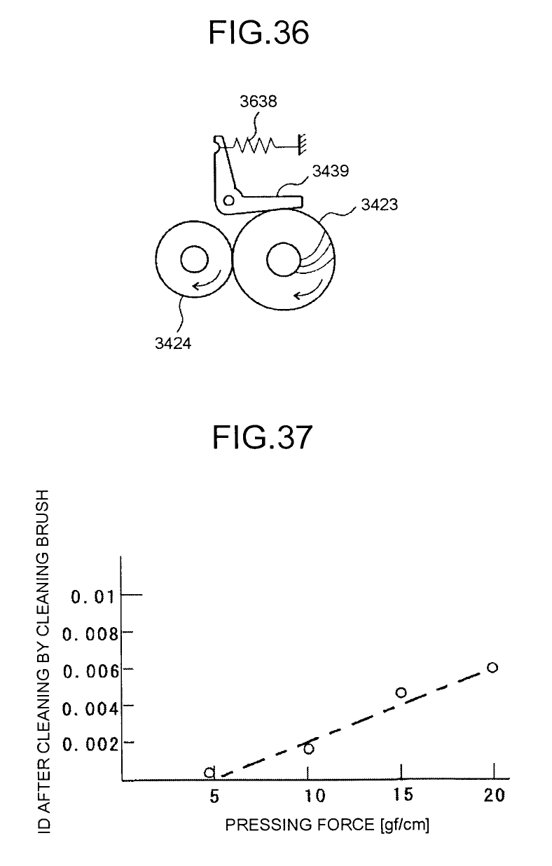

As shown in FIG. 36, a coil spring 3638 with low load being an elastic spring element that is the biasing unit may bias the brush charge imparting unit 3439 to be pressed against the cleaning brush 3423. More specifically, pressing force of the coil spring 3638 only has to be 5 gf/cm or less.

FIG. 37 is a graph representing a relationship between pressing force and cleaning performance when the pressing force by the coil spring 3638 is changed.

As shown in FIG. 37, when the pressing force is increased, then the amount of toner scattering naturally increases, and thus the cleaning performance decreases.

It is experimentally found that if the pressing force becomes 20 gf/cm or more, the amount of toner scattering is about the same as that in the case of the contact depth of 1 millimeter when the cleaning-brush charge imparting unit 39 is fixedly arranged to the cleaning brush 23 as shown in FIG. 1.

The biasing unit that biases the brush charge imparting unit 3439 toward the cleaning brush 3423 is not limited to the spring element such as the coil spring 3638.

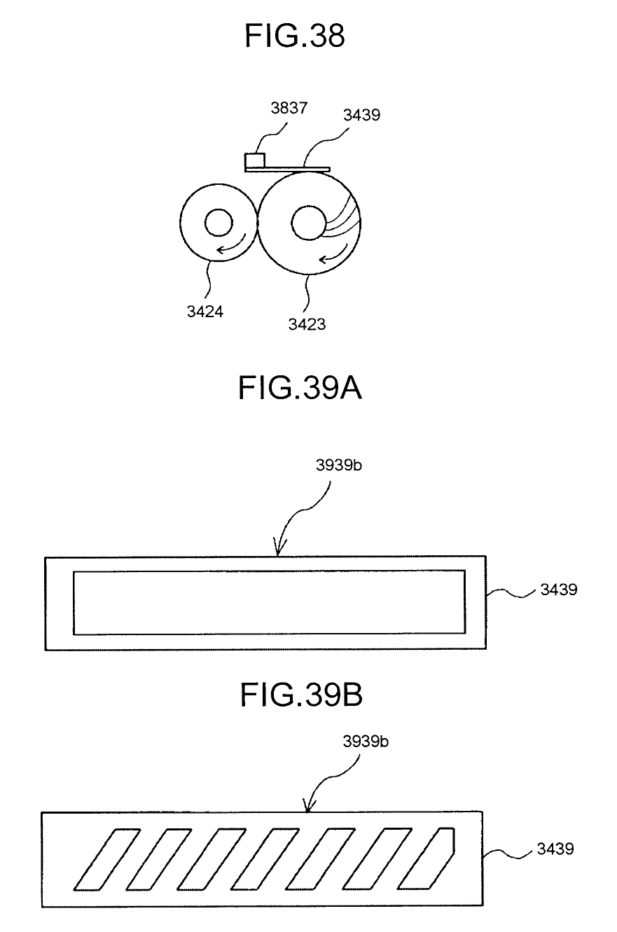

As shown in FIG. 38, the brush charge imparting unit 3439 may be biased toward the brush fibers 31 of the cleaning brush 3423 using the elastic force of the brush charge imparting unit 3439 being the biasing unit, to be brought into contact with the brush fibers 31. In the configuration shown in FIG. 38, the brush charge imparting unit 3439 is a plate spring that is an elastic element and has a thickness of 0.05 millimeter. The brush charge imparting unit 3439 formed of the plate spring is fixed at its one end to the cleaning device 20 by a fixing portion 3837, and the other end is biased toward the cleaning brush 3423 by elasticity of the plate spring, to be pressed to and come in contact with the cleaning brush 3423. Even if the configuration in which the spring element is provided as shown in FIG. 38, if the pressing force against the cleaning brush 3423 is too high similarly to the coil spring 3638, the amount of toner scattering increases and cleaning performance thereby decreases. Therefore, the pressing force by the plate spring is set to a lower value. Specifically, any spring is used so that a contact depth of the brush charge imparting unit 3439 to the cleaning brush 3423 becomes 1 millimeter in design.

FIGS. 39A and 39B are enlarged schematics of the brush-charge imparting unit 3439 formed of the plate spring. Numeral 3939b in FIGS. 39A and 39B represents an edge of the brush charge imparting unit 3439 that contacts the cleaning brush 3423. To keep the contact depth and decrease the pressing force, by punching the brush-charge imparting unit 3439 formed of the plate spring as shown in FIG. 39A or FIG. 39B, the pressing force can be sufficiently decreased.

By devising the thickness and the shape of the plate in the above manner, the pressing force can be set to 5 gf/cm or less even in a pressing method of fixing a one end of the spring element.

The photosensitive element 1 also functions similarly to the flicker bar 4043 between the photosensitive element 1 and the cleaning brush 3423, and the toner scatters and then adheres to the photosensitive element 1. However, a place where the toner scatters is in the upstream side of the contact position between the photosensitive element 1 and the cleaning brush 3423 in the surface movement direction of the photosensitive element 1, so that the toner adhering to the photosensitive element 1 is again conveyed to the contact portion between the photosensitive element 1 and the cleaning brush 3423, to be electrostatically or mechanically removed.

The toner having scattered and electrostatically adhering to the cleaning brush 3423 remains as “one polarity” or “non-charged” without reversal of the polarity caused by scattering. Thus, if the toner has “one polarity”, then the toner is naturally removed from the photosensitive element 1 by means of electrostatic force, and if it is “non-charged”, adhesion force between the photosensitive element 1 and the toner is extremely low, so that the toner is easily mechanically flicked.

The toner having scattered does not therefore affect the photosensitive element 1 after being cleaned by the cleaning brush 3423. It is noted that the contact depth of the cleaning brush 3423 to the photosensitive element 1 is 1 millimeter.

A relationship between the collecting roller 3424 and the cleaning brush 3423 is the same as the relationship between the photosensitive element 1 and the cleaning brush 3423, and thus the cleaning brush 3423 is pressed into the collecting roller 3424 by 1 millimeter. Therefore, the collecting roller 3424 functions as the flicker bar with respect to the cleaning brush 3423. The toner having moved from the photosensitive element 1 to the cleaning brush 3423 is conveyed to the contact portion with the collecting roller 3424, and most of the toner moves to the collecting roller 3424 by means of a potential difference between the cleaning brush 3423 and the collecting roller 3424, and the amount of the toner having moved is about 90%.

Consequently, 10% toner in the rest of input toner scatters in the upstream side of the contact portion between the cleaning brush 3423 and the collecting roller 3424 in the rotational direction of the collecting roller 3424. In this case also, the toner having scattered on the collecting roller 3424 has “one polarity” or is “non-charged” toner. Thus, when the toner is conveyed to the contact portion between the cleaning brush 3423 and the collecting roller 3424, the one-polarity toner again moves to the collecting roller by the electrostatic force because an applied voltage to the collecting roller 3424 is a higher voltage with the positive polarity than the cleaning brush 3423, while the non-charged toner is mechanically scraped off because the adhesion force between the collecting roller 3424 and the toner is extremely low.

In any of these cases, the toner having scattered on the collecting roller 3424 does not affect the photosensitive element 1 after being cleaned by the cleaning brush 3423.

A specific configuration of an electrostatic cleaning unit of the cleaning device 3420 is explained below.

Material of cleaning brush: conductive polyester

Length of fiber: 5 mm

Contact depth of cleaning brush to photosensitive drum: 1 mm

Linear velocity of cleaning brush: 200 mm/s (same as linear velocity of photosensitive element)

Applied voltage to brush-charge imparting unit: 600 V

Applied voltage to shaft of cleaning brush: 600 V

Resistance of brush original yarn: 1×108 Ω·cm

Filling density of brush fibers: 100000 lines/inch²

Form of brush: inclined toward downstream side in the rotational direction of brush

Material of collecting roller: PVDF tube (100 μm) around SUS core metal, surface layer of the tube: UV coating layer

Diameter of collecting roller : φ10 mm

Linear velocity of collecting brush: 200 mm/s

Applied voltage to shaft of collecting brush: 900 V

Applied voltage to collecting-roller cleaning blade: 1200 V

In the device used in the explanation, a volume resistivity of the collecting-roller cleaning blade 27 is 1×108 Ω·cm, however, an effect due to imparting of the charge increases if a low-resistance blade material is selected in a range of causing the cleaning performance of the toner on the collecting roller 3424 not to be decreased. It is desirable to select a blade material so that a resistance of the collecting-roller cleaning blade 27 does not increase particularly at low temperature and low humidity although there is not much problem with high temperature and high humidity.

As similarly shown in FIG. 7, even if each brush fiber 31 of the cleaning brush 3423 has the core sheath structure and is inclined in the rotational direction, the toner on the photosensitive element 1 is moved by means of an electric field between the internally provided conductive material 32 of the brush fiber 31 and the photosensitive element 1 through the insulating material 33 formed on the surface portion of the brush fiber 31 and by means of an electric field between the conductive material 32 and the surface potential of the collecting roller 3424. It is thought that the movement of the toner in the above manner causes the surface potential of fibers to decrease, and the tip potential of the fibers thereby decreases.

Specifically, in the cleaning brush 23 of which each fiber whose surface portion is formed of uniformly dispersed conductive material is straight or inclined, the surface potential of the fibers does not decrease. Therefore, the decrease in the surface potential of the fibers occurs in a combination of an inclined brush made of fibers with the core sheath structure and the high-resistance or insulated collecting roller, as explained in the cleaning device 3420 according to the second embodiment.

Further, a voltage with opposite polarity to the above-mentioned configuration may be applied to the polarity control blade 22, the cleaning brush 23 or the cleaning brush 3423, the collecting roller 24 or the collecting roller 3424, and the collecting-roller cleaning blade 27 of the cleaning device 20 shown in FIG. 1 and of the cleaning device 3420 shown in FIG. 34. More specifically, a voltage with the positive polarity is applied to the polarity control blade 22, and a voltage with the negative polarity is applied to the cleaning brush 23 or the cleaning brush 3423, the collecting roller 24 or the collecting roller 3424, and the collecting-roller cleaning blade 27. In this case, a voltage with the negative polarity which is the opposite polarity to that of the configuration is also applied to the cleaning-brush charge imparting unit 39 or to the brush-charge imparting unit 3439. By applying the positive polarity voltage to the polarity control blade 22, charged polarities of the residual toner particles passing through the contact portion between the surface of the photosensitive element 1 and the polarity control blade 22 are made uniform to the positive polarity. The toner particles with the uniform positive polarity are removed from the surface of the photosensitive element 1 by the cleaning brush 23 or the cleaning brush 3423, the collecting roller 24 or the collecting roller 3424, and the collecting-roller cleaning blade 27 which are applied with the negative polarity voltage.

The method of removing toner on the photosensitive element 1 and the conductive base, and toner on the collecting roller 3424 used in the image forming apparatus according to the second embodiment is the same as that of the first embodiment. Moreover, the example of applying the cleaning device 3420 according to the present invention to the color image forming apparatus is also the same as that explained in the first embodiment.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A cleaning device comprising:
a brush roller including conductive brush fibers that extend outward from an outer periphery of a conductive rotating shaft in a radial direction, the brush roller rotating around the rotating shaft so that the brush fibers make contact with a cleaning target having a moving surface to remove dirt from the surface of the cleaning target;
a first voltage applying unit that applies a voltage to the rotating shaft;
a brush-roller cleaning unit that makes contact with the brush fibers at a location different from a location where the brush fibers make contact with the cleaning target, and removes the dirt from the brush fibers;
a brush-fiber charge imparting unit that makes contact with the brush fibers on a downstream side of a location where the brush-roller cleaning unit makes contact with the brush fibers in a rotation direction of the brush roller and on an upstream side of a location where the brush fibers make contact with the cleaning target in the rotation direction of the brush roller, and is applied with a voltage with same polarity as the voltage applied to the brush fibers; and
a second voltage applying unit that applies the voltage to the brush-fiber charge imparting unit, wherein
each of the brush fibers has an inner portion formed of a conductive material and a surface portion formed of an insulating material.

2. The cleaning device according to claim 1, wherein a length of the brush-fiber charge imparting unit is equal to or longer than a length of the brush roller in a direction of the rotating shaft.

3. The cleaning device according to claim 1, wherein the brush fibers are inclined backward in the rotation direction of the brush roller.

4. The cleaning device according to claim 1, wherein
the cleaning target is a photosensitive element on which a toner image is formed,
the dirt is residual toner that is left on the photosensitive element after the toner image is transferred onto a subsequent medium,
the brush-roller cleaning unit is a collecting roller that rotates around a rotating shaft parallel to the rotating shaft of the brush roller, and is applied with a voltage to electrostatically attract the toner from the brush fibers,
the collecting roller includes a roller surface layer formed of either one of an electrically resistive layer and an insulating layer provided on its outer peripheral surface,
the cleaning device further comprises:
a third voltage applying unit that applies the voltage to the collecting roller; and
a collecting-roller cleaning unit that removes the toner from the collecting roller.

5. The cleaning device according to claim 1, wherein
the cleaning target is a photosensitive element on which a toner image is formed,
the dirt is residual toner that is left on the photosensitive element after the toner image is transferred onto a subsequent medium,
the cleaning device further comprises a toner-polarity control unit that makes contact with the photosensitive element in an upstream side of a location where the brush fibers makes contact with the photosensitive element in a direction of surface movement of the photosensitive element, and is applied with a voltage to control a polarity of the toner on the photosensitive element.

6. The cleaning device according to claim 1, wherein the toner on the photosensitive element is spherical toner.

7. The cleaning device according to claim 1, wherein
the brush-fiber charge imparting unit is arranged so that a distance to the rotating shaft is variable, and
the brush-fiber charge imparting unit includes a biasing unit that biases the brush-fiber charge imparting unit toward the brush roller.

8. The cleaning device according to claim 4, wherein a surface resistivity of the roller surface layer is equal to or larger than 1×10¹⁰ Ω/cm².

9. The cleaning device according to claim 4, further comprising:
a roller-surface charge imparting unit that makes contact with the collecting roller, and is applied with a voltage with same polarity as that of the voltage applied to the collecting roller; and
a fourth voltage applying unit that applies the voltage to the roller-surface charge imparting unit.

10. The cleaning device according to claim 5, wherein the toner-polarity control unit is a conductive blade.

11. The cleaning device according to claim 6, wherein a shape factor SF-1 of the spherical toner is 100 to 150.

12. The cleaning device according to claim 7, wherein the biasing unit is configured so that the brush-fiber charge imparting unit biases the brush fibers by gravity.

13. The cleaning device according to claim 7, wherein the biasing unit is an elastic element.

14. The cleaning device according to claim 7, wherein
the brush-fiber charge imparting unit is formed of an elastic element, and
as the biasing unit, the brush-fiber charge imparting unit biases the brush fibers by means of its elastic force.

15. The cleaning device according to claim 9, wherein
the collecting-roller cleaning unit includes a collecting-roller cleaning blade that is formed of a conductive material and that makes contact with the collecting roller to scrape off the toner from the collecting roller, and
the roller-surface charge imparting unit is the collecting-roller cleaning blade.

16. An image carrier unit that integrally supports an image carrier as a cleaning target and a cleaning unit that cleans a surface of the image carrier, and is installed in an image forming apparatus in a detachable manner, wherein
the cleaning unit includes
a brush roller including conductive brush fibers that extend outward from an outer periphery of a conductive rotating shaft in a radial direction, the brush roller rotating around the rotating shaft so that the brush fibers make contact with the image carrier to remove toner from the surface of the image carrier;
a first voltage applying unit that applies a voltage to the rotating shaft;
a brush-roller cleaning unit that makes contact with the brush fibers at a location different from a location where the brush fibers make contact with the image carrier, and removes the toner from the brush fibers;
a brush-fiber charge imparting unit that makes contact with the brush fibers on a downstream side of a location where the brush-roller cleaning unit makes contact with the brush fibers in a rotation direction of the brush roller and on an upstream side of a location where the brush fibers make contact with the image carrier in the rotation direction of the brush roller, and is applied with a voltage with same polarity as the voltage applied to the brush fibers; and
a second voltage applying unit that applies the voltage to the brush-fiber charge imparting unit, and
each of the brush fibers has an inner portion formed of a conductive material and a surface portion formed of an insulating material.

17. An image forming apparatus comprising:
an image carrier;
a charging unit that charges the image carrier;
a latent image forming unit that forms the latent image on the image carrier;
a developing unit that develops the latent image formed on the image carrier using toner so that a toner image is formed on the image carrier;
a transfer unit that transfers the toner image from the image carrier to a subsequent medium; and
a cleaning unit that removes residual toner from the image carrier after the toner image is transferred, wherein
the cleaning unit includes
a brush roller including conductive brush fibers that extend outward from an outer periphery of a conductive rotating shaft in a radial direction, the brush roller rotating around the rotating shaft so that the brush fibers make contact with the image carrier to remove toner from the surface of the image carrier,
a first voltage applying unit that applies a voltage to the rotating shaft,
a brush-roller cleaning unit that makes contact with the brush fibers at a location different from a location where the brush fibers make contact with the image carrier, and removes the toner from the brush fibers,
a brush-fiber charge imparting unit that makes contact with the brush fibers on a downstream side of a location where the brush-roller cleaning unit makes contact with the brush fibers in a rotation direction of the brush roller and on an upstream side of a location where the brush fibers make contact with the image carrier in the rotation direction of the brush roller, and is applied with a voltage with same polarity as the voltage applied to the brush fibers, and
a second voltage applying unit that applies the voltage to the brush-fiber charge imparting unit, and
each of the brush fibers has an inner portion formed of a conductive material and a surface portion formed of an insulating material.
